(19) United States
(12) Patent Application Publication
(10) Pub. No.: US 2018/0322241 A1
(43) Pub. Date: Nov. 8, 2018

(54) BIOLOGICAL ORGANISM DEVELOPMENT SYSTEM

(71) Applicant: Charles L. Buchanan, Houston, TX (US)

(72) Inventor: Charles L. Buchanan, Houston, TX (US)

(21) Appl. No.: 16/038,592

(22) Filed: Jul. 18, 2018

Related U.S. Application Data
(63) Continuation-in-part of application No. 14/584,154, filed on Dec. 29, 2014, now abandoned.
(60) Provisional application No. 62/013,736, filed on Jun. 18, 2014.
(60) Provisional application No. 61/921,174, filed on Dec. 27, 2013.

(51) Int. Cl. G06F 19/12; G06N 3/063; G06N 3/08; G06F 19/24

(52) U.S. Cl. CPC G06F 19/12; G06F 19/24; G06N 3/084; G06N 3/0635

(57) ABSTRACT

An organism development system includes: at least one neuromorphic device including multiple sets of hardware components that each store one or parameters of neuromorphic configuration data to implement a neuron of a neural network, wherein: the neural network is configured by neuromorphic configuration data to derive a proposed genome or epigenome of a new organism meant to have a sought-for trait, and the neuromorphic configuration data is generated by training the neural network with a usage data set that includes trait data indicative of a trait and biological data indicative of a genome for each of multiple organisms; a genome or epigenome printing device to print genetic/epigenetic material of the new organism based on the proposed genome or epigenome, respectively; and a trait detection device to detect an observed trait of the new organism following its at least its generation for incorporation back into the usage data set.

### RELATED APPLICATIONS

This application is a continuation-in-part of U.S. patent application Ser. No. 14/584,154 entitled “LINKAGE MAPPING PROCESS PROVIDING BOTANICAL PHENOTYPE TRANSLATION FOR PLANT-BASED CHEMICAL BY-PRODUCT DEVELOPMENT” filed Dec. 29, 2014 by Charles L. Buchanan, the disclosures of all of which is incorporated herein by reference for all purposes. U.S. patent application Ser. No. 14/584,154 claims the benefit of the priority date of each of U.S. Provisional Application 61/921,174 filed Dec. 27, 2013 and of U.S. Provisional Application 62/013,736 filed Jun. 18, 2014, the disclosures of both of which are also incorporated herein by reference for all purposes.

### BACKGROUND OF THE INVENTION

### 1. Field of the Invention

The present invention relates to the field of non-zoological botanical organism selective breeding or genetic modification for commercially valuable functional improvements, including chemical, biofuel, and agribusiness production purposes. More particularly, the present invention relates to the integration of advanced chemical analysis technology with genetic analysis technology using the pattern recognition abilities of cognitive computing in a sequenced process to identify, analyze, and interpret patterns within the genetic code of organisms that are responsible for determining a broad range of functional attributes, including customizing chemical by-product output, enhanced photosynthesis and growing processes, increased yields, shorter growing cycles, improved nutrient metabolism and moisture conservation, as well as greater environmental hardiness and tolerance to pests, disease, and poor soil conditions. The present invention also relates to devices for developing biological organisms.

### 2. Description of the Related Art

Plant breeding has been practiced for thousands of years and allows for changing the genetic makeup of plants to produce desired functional results. Modern breeding of both plant and other botanical organisms like algae, fungi, bacteria, yeasts, and molds allows for the inclusion of commercially desirable traits. Genetic screening allows scanning the DNA of an organism to identify the genetic code of those organisms having desirable functional traits, or benefits of interest. The advent of functional genomic screening of the RNA and mRNA transcriptome now allows the identification of those plants with beneficial responses to environmental conditions as well. What is still missing is the ability to understand and characterize the genetic patterns, or phenotypes, which determine those functional, beneficial results. Modern genetic modification essentially involves changing the gene sequence wherein a gene or a number of genes are added to the genum of an organism in order to build a desired phenotype pattern that will produce the desired functional improvement in the organism. A gene or a number of genes can also be removed from, or replaced in, the genum of a botanical organism.

Various methods of plant breeding are used in modern times. A variety of techniques that now allow genetic modification of plants for functional improvement are also becoming commonplace, and as they are, the means of making these modifications are becoming more efficient and effective. The missing key to the efficient bioengineering of desired functional improvements in botanical organisms is still the ability to fully understand and characterize the relationship between the observed phenotype pattern in an organism's genetic code (both its DNA sequence and its protein transcripts that regulate gene expression) and the functional attributes they determine that are exhibited by that botanical organism.

In one currently popular method of genetic modification, a large and important group of plants (Dicotyledonous plants, which include many commercial plant species like tobacco and tomatoes), bacteria can be used to insert genetic construct implants into a plants genetic code. Agrobacterium is a genus of Gram-negative bacteria established by H. J. Conn that uses horizontal gene transfer to cause tumors in plants. Agrobacterium tumefaciens is the most commonly studied species in this genus. Agrobacterium is well known for its ability to transfer DNA between itself and plants, and for this reason it has become an important tool for genetic engineering. In 1983, Shilperoort et al., taught in U.S. Pat. No. 4,940,838A a process for the incorporation of foreign DNA into the genome of dicotyledonous plants. The invention relates to a process that incorporates foreign DNA into chromosomes of dicotyledonous plants by infecting the plants or incubating plant protoplasts with Agrobacterium bacteria, which contain one or more plasmids, wherein bacteria are used which contain at least one plasmid having the vir-region of a Ti (tumor inducing) plasmid but no T-region, and at least one other plasmid having a T-region with foreign DNA incorporated therein but no vir-region, as well as an Agrobacterium bacteria wherein at least one plasmid which has the vir-region of a Ti (tumor inducing) plasmid but no T-region and at least one other plasmid which has a wild type T-region with foreign DNA incorporated in it but no vir-region. Another common method involves the use of a gene gun (biolistic method), or microinjection.

In 1984 Sanford et al., taught in U.S. Pat. No. 4,945,050A how inert or biologically active particles are propelled at cells at a speed whereby the particles penetrate the surface of the cells and become incorporated into the interior of the cells. The process can be used to mark cells, or tissue, or to biochemically affect tissues or tissue in situ, as well as single cells in vitro. Apparatus for propelling the particles toward target cells or tissues are also disclosed. A method for releasing particles adhered to a rotor device is disclosed as well.

In 1998 Maliga et al., taught in U.S. Pat. No. 6,987,215B1 translation control elements and methodology for high-level protein expression in the plastids of higher plants. DNA constructs containing translational control elements are provided. These 5′ regulatory segments facilitate high level expression of transgenes introduced into the plastids of higher plants, allowing modification of gene expression control, and thereby it's response to environmental conditions.

One new method for producing genetically modified organisms that will work particularly well in conjunction with the present invention is the 3D Genetic Material Printer developed by Cambrian Genomics. This printer allows the digitally stored modified genetic coding of a hybrid plant bioengineered with this invention to be simply printed out in a DNA sequence for genetic modification of the organism. [The portfolio of related art taught from 2004 to 2011 include: Coherent electron junction scanning probe interference microscope, nanomanipulator and spectrometer with assembler and DNA sequencing applications—US 20070194225 A1; Sequencing of nucleic acids—US 20110008775 A1; Biological laser printing via indirect photon-biomaterial interactions—U.S. Pat. No. 7,875,324 B2; Biological laser printing via indirect photon-biomaterial interactions—US 20050018036 A1; Methods and apparatuses for mems-based recovery of sequence verified DNA—US 20140008223 A1; Methods and apparatuses for mems-based recovery of sequence verified DNA—WO 2013101773 A1].

Plants modified to produce pharmaceuticals by genetic modifications or plant breeding, also known as pharmacrops, are also frequently produced by splicing genetic material onto a common food crop, which offers the chance of dangerous inter-field contamination of food crops. Russell and Schlittler taught in 2001 in US 20030167531A1 a process for the production of proteins or polypeptides using genetically manipulated plants or plant cells, as well as to the genetically manipulated plants and plant cells per se (including parts of the genetically manipulated plants), the heterologous protein material (e.g., a protein, polypeptide and the like) which is produced with the aid of these genetically manipulated plants or plant cells, and the recombinant polynucleotides (DNA or RNA) that are used for the genetic manipulation. Their invention contemplated producing bioactive cytokines from plant host systems. These cytokines maybe any mammalian soluble protein or peptide which acts as a humoral regulator at the nano- to pico-molar concentration, and which either under normal or pathological conditions, modulate the functional activities of individual cells and tissues. Furthermore, the cytokines may also mediate interactions between cells directly and regulate processes taking place in the extracellular environment. They belong to the cytokine superfamilies', which include, but are not limited to: the Tumor Growth Factor-beta (TGF-beta) superfamily (comprising various TGF-beta isoforms, Activin A, Inhibins, Bone Morphogenetic Proteins (BMP), Decapentaplegic Protein (DPP), granulocyte colony stimulating factor (G-CSF), Growth Hormone (GH) (including human growth hormone (hGH)), Interferons (IFN), and Interleukins (IL)); the Platelet Derived Growth Factor (PDGF) superfamily (comprising VEGF); the Epidermal Growth Factor (EGF) superfamily (comprising EGF, TGF-alpha, Amphiregulin (AR), Betacellulin, and HB-EGF); the Vascular Epithelial Growth Factor (VEGF) family; Chemokines; and Fibroblast Growth factors (FGF).

These are powerful pharmacological agents which could prove dangerous if cross-pollination occurred with food crops being grown in nearby fields, or there was a failure to follow a ‘fallow season’ rule and a food crop was grown in a field the season following one where a transgenic crop was grown in that same field. What has been lacking to prevent such a tragic occurrence has been an accurate method to understand and interpret the functional genomic linkage between the genetic pattern of a botanical organism and the chemicals it produces. This will allow botanical organisms to be bioengineered with distinct features and obvious markers that will clearly differentiate food crops from non-food crops.

Genetically modified crops are very common presently. These crops or botanical organisms are modified for various reasons, including resistance to herbicides as well as tolerance of pests and diseases. Genetically modified botanical organism crops like plants, algae, microalgae, and molds are also used in the production of biofuels, pharmaceuticals, food crops, oils, waxes, resins, polymers, and are finding their way into other industrial and commercial applications every day. Most of these genetic modifications are accomplished by trial-and-error, either by searching for random, naturally-occurring, desirable mutations in a sample population; introducing stressors that produce an increase in random genetic mutations; or by splicing suspect genetic construct implants into a host botanical organism and monitoring the outcome for desired results. The present invention offers a systematic process integrating heretofore underutilized abilities in two current advanced analytical technologies with the cognitive computing technology of RBF non-linear classifiers to map genetic patterns to their functional results in botanical organisms.

Biofuel producers are currently heavily invested in research in an attempt to develop new genetic modifications in a variety of common organisms like red and green algae, white and brown molds, and also a variety of yeasts and bacteria, to introduce changes in their genetics offering commercial benefits such as bioengineering the lignin degradation pathway in organisms to produce specific custom hydrocarbon compounds, or improving hydrocarbon yields through a more efficient conversion of sugars to hydrocarbons, or delivering other functional and commercially valuable improvements. Biofuel production processes involving higher order plants can also incorporate other beneficial results like enhanced photosynthesis, a shorter growing cycle, higher yields, and lower growing costs.

In 1980 Axel et al., taught in U.S. Pat. No. 4,399,216A processes to insert DNA into eucaryotic cells to produce proteinaceous materials, and Nonomura taught in 1985 in U.S. Pat. No. 4,680,314A a process for producing a naturally-derived carotene and oil composition by direct extraction from algae without the use of petroleum-based solvents. Clayton et al., taught in 2008 in U.S. Pat. No. 8,512,998B2 a continuous process for recovering and concentrating valuable components from microalgae such as algal oils for use as biofuel feedstocks by utilizing agitation with solid particles, followed by adsorptive bubble separation.

Harvesting commercially valuable compounds using microbial and algal organisms has a long history, including genetic modification of microbial and algal organisms producing a variety of improvements in commercial products, including biofuels, chemical feedstocks, and nutritional products composed of oils, waxes, resins, and lipids. These have become increasingly commonplace, but a lack of understanding of the botanical organism's phenotype/analyte relationship has hampered the ability to cost-effectively bioengineer greater efficiencies and improve the ability to scale production to large quantities.

Moore and Benjamin taught in U.S. Pat. No. 3,280,502A the process for the preparation of lutein using an algal strain, and later Franklin et al., taught in U.S. Pat. No. 7,935,515B2 one of the early methods of developing recombinant microalgae cells for the production of novel oils [genus Prototheca comprising an exogenous fatty acyl-ACP thioesterase gene; makes biofuel feedstock triglyceride; algal oils with shorter chain length and a higher degree of saturation and without pigments]. Perhaps some of the most well-known genetically modified crops fall into the category of “Roundup Ready®”. These plants or seeds are produced by Monsanto and are resistive to the herbicide Roundup®, which is also produced by Monsanto. Roundup Ready® crops include corn, soybeans, alfalfa, canola, sugar beets and cotton.

U.S. Pat. No. 5,554,798, issued on Sep. 10, 1996 to Lundquist et al., is one of a number of patents which covered the Roundup Ready® corn plant. The '798 patent describes fertile glyphosate-resistant transgenic corn plants. Fertile transgenic Zea mays (corn) plants which stably express heterologous DNA which is heritable are provided along with a process for producing said plants. The preferred process comprises the microprojectile bombardment of friable embryogenic callus from the plant to be transformed. The process may be applicable to other graminaceous cereal plants which have not proven stably transformable by other techniques. U.S. Pat. Nos. 5,593,874, 5,641,876, 5,717,084, 5,728,925, 5,859,347, 6,025,545, 6,083,878, 6,825,400, 7,582,434, 8,273,959 and RE39247 are also part of the patent portfolio for Roundup Ready® corn plants.

Accurate functional genomic bioengineering would allow customization of a broad array of environmental responses by the plant to specific environmental conditions by selecting for those identified transgene regulatory segments. With the understanding of the functional genomic coding of a plant species and the ability to modify its high-level protein expression, it is possible to program its responses to rainfall; soil conditions; heat/cold; pests; as well as fungal, bacterial, and viral diseases. This would offer tremendous cost savings in the process of growing plants for commercial and agricultural purposes worldwide.

One of the more controversial common plants currently subject to genetic modification or plant breeding for medical purposes is cannabis, or marijuana. Cannabis is a genus of flowering plants that includes three putative varieties, Cannabis sativa, Cannabis indica, and Cannabis ruderalis (collectively referred to herein as cannabis). Cannabis is subject to modification for both recreational and medicinal usage. Medicinal usage of cannabis is becoming ever more popular in the United States, as more and more states legalize or decriminalize the usage of cannabis for medicinal purposes. While still primarily taken in ‘herbal remedy’ form today, research is actively underway to isolate the active components for pharmaceutical preparations but that is complicated by the fact that these extracts being studied, known as analytes, must be analyzed both for their molecular composition (for the 85 possible cannabinoid molecules as well as other potentially therapeutic molecules that could be present), and also for which of the possibly 100+ isomers that are possible for each of those molecules are present. These isomers are now able to be identified by their unique signature, determined by detecting the position of its carbon ring using infrared mass spectroscopy.

This technology today is designed, and primarily used, to determine the presence or absence of a specific target isomer, as in investigations for the presence of illegal drugs or toxic contaminants, but if the analysis pattern produced of the extracted analyte is viewed in total it is in effect a pattern that fully identifies and quantifies the components contained in the analyte, which not only identifies and quantifies the molecules present, but also identifies their relative carbon-ring positions, which further identifies the relative quantity of the individual isomers of these molecules that are present. Thus, this complex pattern completely and accurately describes the analyte(s) being tested and thereby completely and accurately describes the botanical organism's chemical by-product composition.

A pattern completely describing an analyte at the isomeric level also defines its functional attributes, describing exactly what it will do both in important chemical reactions needed in biofuels, biomass power generation, chemical feedstocks, and other industrial applications, but this isomeric-level granularity is especially important in medical and nutritional products because we react to food, nutritional supplements, and medicines we consume based on which isomers of which molecule we ingest. Largely, therapeutic effects of medicines are produced when a desired isomer in the pharmaceutical compound bonds with a matching receptor in the body, similar to a ‘lock and key’ mechanism. Other undesired isomers of that molecule, if present, may similarly bond with that same receptor, but will produce other, potentially undesirable results. This is the suspected root cause of many allergic reactions and pharmaceutical side effects, and the reason for the necessity of a ‘batch’ process in pharmaceutical production.

For example, cannabis contains a diverse class of chemical compounds known as cannabinoids. One notable cannabinoid is Tetrahydrocannabinol (THC). THC (specifically its main isomer (−)-trans-.DELTA.9-tetrahydrocannabinol) is a primary psychoactive component of cannabis and the source of one of the euphoric effects experienced when cannabis is consumed, but the wide variety of reported effects are attributed to the ‘entourage effect’ of the combination of one or more other isomers of THC, or possibly various isomers of other cannabinoids as well.

Aside from THC, cannabis contains eighty-five other cannabinoids, each of them potentially configured in many isomeric forms, some with as many as 146 configurations, each different, and often producing different effects or no effect at all. Cannabidiol (CBD) is also another major cannabinoid constituent of the cannabis plant. It has been well established that the different cannabinoids which have been isolated from cannabis have different effects on the user. The factor differentiating these effects and their potency is which isomers of which cannabinoids are present in what quantities in the oil produced by the plant, and because the numbers of possible combinations are vast, completely isolating production to a single isomer through genetics has not been possible, and separating a compound at the isomeric level physically after extraction is not economically feasible.

An isomer is one of two or more compounds having identical molecular formula and weight, but differing in the arrangement or configuration of the atoms. Isomers of the same molecule often show different chemical reactions with other substances that are also isomers. Since many molecules in the bodies of living beings are also isomers themselves, there is often a marked difference in the effects of two isomers on living beings. In drugs, for example, often only one of a molecule's isomers is responsible for the desired physiologic effects, while other isomers of that molecule may be less active, inactive, or sometimes even responsible for adverse effects, including extremely toxic ones.

These isomers are so chemically similar that there is currently no way to physically separate them with a chemical process, so they must be included in, or removed from, the desired mix (at the desired concentration) by selective breeding or genetic modification within the botanical organism feedstock prior to extraction. Until recently, any attempt to do even the simplest quantitative analysis at the isomeric level was extremely difficult, time-consuming, and incredibly expensive, with only mixed results, while requiring large capital investment in both equipment and lab time.

Each of the eighty-five or more cannabinoids from cannabis can have a number of isomers and stereo isomers, which may have different effects and efficacy. In addition to the three species of cannabis plants that produced cannabinoids, other plants like Echinacea, acmella, heliachrysum, and radula also produce cannabinoid isomers and offer similar promise medically, if the isomers with therapeutic effects could only be identified, isolated and concentrated.

Cannabinoids interact with membrane bond receptors CB1 and CB2. CB1 receptors, which are most commonly found in the brain, are responsible for the euphoric and anticonvulsive effects of cannabis. CB2, on the other hand, is found mostly in the immune system, and cannabinoid attachment on the CB2 receptor is thought to be responsible for the anti-inflammatory and possibly other therapeutic effects. Newer studies suggest other receptors may be located throughout the body.

CBD has been shown to possibly relieve convulsion, inflammation, anxiety and nausea effects, mostly at CB2 receptors. Relief of nausea is one of the primary reasons why cannabis is used for patients undergoing cancer treatment, and why it serves as an appetite stimulant due to the relief of nausea. Further, some research has shown that CBD in sufficient concentrations may also “turn off” the activity of the LD1 gene, which is the gene expression responsible for metastasis in breast cancer and many other types of cancers. It is also suspected to restrict the oxygen uptake of tumor-producing cancer cells, essentially suffocating them, while not affecting healthy cells.

Different strains of a pharmacrop used to produce a pharmaceutical product may produce different isomers of the active molecule being extracted. For example, cannabis plants produce eighty-six different cannabinoids (and potentially even more different isomers than that are possible with many of these cannabinoids), which influence and determine the medicinal effects from the usage of cannabis. Some cannabinoids are also antagonistic of others. For example, THCV attenuates the psychoactive effects of THC. It is also known that in many medicines derived from plants, the same plant producing the therapeutic isomer frequently also produces one or more antagonist isomers that either nullify or attenuate the therapeutic effect or have even more serious side effects.

Perhaps one of the most notable examples of isomers from a particular compound causing adverse effects involved the 1970's birth defect crisis associated with women taking the drug Thalidomide during pregnancy. A change in plant feedstock to a different, though almost identical variety of the same species resulted in a different mix of isomers of the Thalidomide molecule. The previously unknown isomer caused horrific birth defects in the children these women were carrying.

As noted above, cannabis has been the subject of vigorous selective breeding, and with legalization will likely be the target of increased genetic modification efforts. For example, cannabis strains used to produce hemp may be bred so that they are low in THC, the psychoactive chemical within the cannabis plant, but whose fibers exhibit a comparatively high strength-to-weight ratio. Similarly, strains which are used medicinally are often bred specifically for high CBD content. Conversely, strains used exclusively for recreational purposes are bred to contain high amounts of THC for a greater psychoactive or euphoric affect. Cannabinoids can be administered by smoking, vaporizing, oral ingestion, transdermal patch, intravenous injection, sublingual absorption, or rectal suppository. Most cannabinoids are then metabolized in the liver.

So that the cannabinoids can be ingested in manners other than smoking, vaporizing or oral ingestion, the cannabinoids are commonly separated from the plant. This often is accomplished through the use of organic solvents such as hydrocarbons and alcohols, or through mechanical means such as liquid CO.sub.2.

Liquid chromatography-mass spectrometry (LC-MS) is commonly used to identify the chemical composition of a sample (analyte) or plant. Gas chromatography-mass spectrometry (GC-MS) is also used. However, the use of LC-MS and GC-MS alone do not allow for the identification of compounds at the isomeric level. LC-MS is commonly used in drug and other chemical production testing at different stages of the development including quality control.

Recently, new technology has become available which would allow for relatively easy quantitative analysis of compounds at the isomeric level. The DiscovIR system produced by Spectra Analysis, Inc. described in U.S. Pat. No. 7,590,196B2 [Chiral mixture detection system using double reference lock-in detector], combines a High Performance Liquid Chromatograph (HPLC) with infrared spectra analysis to produce a isomeric-level molecular analysis of an analyte in order to detect the presence of a specific targeted isomer within a complex organic compound.

In 1956 Dawson, Jr. taught multiple column gas chromatography for chemical analysis in U.S. Pat. No. 3,234,779A, and later in 1956 Tracht teaches an improved methodology and apparatus for gas chromatography. In 1962, William teaches liquid chromatography in U.S. Pat. No. 3,292,420A. HPLC, or High Performance Liquid Chromatography, is a separation technique in which a chemical sample is forced by a liquid at high pressure (the mobile phase) through a column that is packed with a stationary phase composed of irregularly or spherically shaped particles, a porous monolithic layer, or a porous membrane. The various constituents of the mixture travel at different speeds, causing them to separate. The HP-LC delivers this column eluent to the infrared mass spectroscope (i.e. Spectra Analysis' DiscovIR Test Station) and it is direct deposited in eluted peaks on a moving, cryogenically cooled IR-transparent sample disc as an infrared beam passes through each concentrated spot and the detector automatically collects the spectral data.

This technology is traditionally used to search for the presence of a specific analyte as in chemical component identification like illegal or toxic substances, along with chemical troubleshooting and failure analysis. Instead, we use the entire dataset of the analyte analysis as one complete pattern, a chemical inventory that accurately and fully describes and identifies the complete, complex organic chemical compound produced by that individual botanical organism, at the isomeric level. We compare this chemical analysis pattern from the mass spec with an equally accurate, equally granular genetic pattern that describes the botanical organism's entire genetic profile, a pattern that can include both the botanical organism's genetic sequence and genomic transcript data.

Single Molecule Real Time Sequencing, also known as SMRT, is a parallelized single molecule DNA sequencing by synthesis technology, the process of determining the precise order of nucleotides within a DNA molecule [developed by Pacific Biosciences (previously named Nanofluidics, Inc.)]. In U.S. Pat. No. 8,501,405B2, filed in 2010 [real-time sequencing methods and systems], Korlach et al., teaches compositions, methods, and systems for performing single-molecule, real-time analysis of a variety of different biological reactions. Other related patents in the Pacific Biosciences of California portfolio include U.S. Pat. No. 8,501,406, U.S. Pat. No. 8,609,421, U.S. Pat. No. 8,389,676, U.S. Pat. No. 8,058,031, U.S. Pat. No. 8,420,366, U.S. Pat. No. 8,053,742, U.S. Pat. No. 8,367,159, U.S. Pat. No. 8,628,940, and U.S. Pat. No. 8,795,961. It includes any method or technology that is used to determine the order of the four bases-adenine, guanine, cytosine, and thymine-in a strand of DNA. Knowledge of DNA sequences has become indispensable for basic biological research, and in numerous applied fields such as medical diagnostics, forensic biology, and virology.

In 2008, Heiner et al., taught in U.S. Pat. No. 8,003,330B2 a method for error-free amplification of DNA for clonal sequencing. Provided are methods of producing low-copy-number circularized nucleic acid variants that can be distributed to reaction volumes. The methods include providing a template nucleic acid; producing a population of clonal nucleic acids from the template nucleic acid; generating a set of partially overlapping nucleic acid fragments from the population of clonal nucleic acids; circularizing the partially overlapping nucleic acid fragments to produce circularized nucleic acid variants; and aliquotting the circularized nucleic acid variants into reaction volumes. Related compositions of nucleic acid templates are also provided.

This was followed by a series of other Pacific Biosciences of California patents from 2009 to 2013 involving methodologies for nucleic acid sample prep, analysis, and sequencing, including U.S. Pat. Nos. 8,153,375B2, 8,236,499B2, 8,501,405B2, 8,609,421B2, U.S. Pat. No. 8,455,193B2, and U.S. Pat. No. 8,535,886B2.

Using the long reads generated by SMRT sequencing, the isoform sequencing method provides reads that span entire transcript isoforms, from the 5′ end to the 3′ polyA-tail. It is now possible to directly sequence full-length transcripts ranging up to 10 kb. Generation of accurate, full-length transcript sequences greatly simplifies this analysis by eliminating the need for transcript reconstruction to infer isoforms using error-prone assembly of short RNA sequence reads. Understanding the complete representation of a sample's gene isoforms increases the sensitivity and specificity of quantitative functional genomics studies. Isoform sequencing also provides information to efficiently detect or validate novel gene fusions, and has also been used to determine allele-specific isoform expression.

In 2000, Korlach et al., taught in U.S. Pat. No. 7,056,661B2 a method for sequencing nucleic acid molecules. The advent of rapid DNA sequencing methods has greatly accelerated biological and medical research and discovery. In 2002, Levene et al., taught in U.S. Pat. No. 6,917,726B2 of zero-mode clad waveguides for performing spectroscopy with confined effective observation volumes, enabling a method and an apparatus for analysis of an analyte. Single molecule real time sequencing utilizes the zero-mode-waveguide (ZMW), an optical waveguide that guides light energy into a small 10-12 liter volume for rapid parallel sensing in gene sequencing applications.

A single DNA polymerase enzyme is affixed at the bottom of a ZMW with a single molecule of DNA as a template. The ZMW is a structure that illuminates a sample volume small enough to observe only a single nucleotide of DNA being incorporated by DNA polymerase. Each of the four DNA bases is attached to one of four different fluorescent dyes. When a nucleotide is incorporated by the DNA polymerase, the fluorescent tag is cleaved off and diffuses out of the observation area of the ZMW where its fluorescence is no longer observable. A detector detects and identifies the fluorescent signal of the nucleotide base by the fluorescence of that specific dye.

In 1992, M. Holler et al., of Intel Corp published in conjunction with Nestor and DARPA, “A High Performance Adaptive Classifier using Radial Basis Functions”, and submitted it to the Government Microcircuit Applications Conference in Las Vegas, Nev., wherein a 1024 neuron RBF/RCE VLSI hardware component was proposed. This initiated a development process, and from 1993 to 2010 Intel/Nestor with DARPA assistance co-developed the NI1000, utilizing a RBF non-linear classifier. Around the same time, IBM validates and patents a similar architecture with a project also utilizing a RBF non-linear classifier. [U.S. Pat. No. 5,717,832 Improved neuron circuit architecture, U.S. Pat. No. 5,710,869—Daisy chain circuit for serial connection of neuron circuits, U.S. Pat. No. 5,701,397—Circuit for pre-charging a free neuron circuit, U.S. Pat. No. 5,740,326—Circuit for searching/sorting data in neural networks].

In 2011, CogniMem Technologies Inc. is established to further develop this technology for the next generation of VLSI ASIC processors targeting RBF non-linear classifier usage models in cognitive computing systems for applications like image recognition, pattern matching, language translation, and genetic analysis.

Utilizing this massively parallel processing approach in conjunction with functional bioinformatics methodologies (including artificial intelligence, Bayesian & Boolean networks and network inference tools), along with the use of functional genomics data, chemical characterization, and leading edge computational biology, this invention will serve as an analytic platform for discovery and improvement that will change the way business is done in agricultural biology, renewable energy sources, textiles and nutritional health.

It is an object of the present invention to utilize infrared spectra analysis technology in conjunction with advanced genetic analysis and RBF non-linear classifier technology so as to produce a pattern map linking genetic patterns to the functional attributes of botanical organisms that will allow the accurate genetic modification of botanical organisms generating desired functional attributes, whether that's producing pure isomers to extract for medicinal, therapeutic, nutritional, or other industrial uses, or its engineering botanical organism species for optimal an response to environmental growing conditions.

It is another object of the present invention to provide a linkage mapping process which allows for the identification and genetic isolation of a specific isomer to determine its medicinal effect, shortening pharmaceutical development time to clinical-trial-ready status and allowing directed genetic concentration of desired effect(s).

It is another object of the present invention to provide a linkage mapping process which allows the identification, for removal, of unwanted antagonistic or harmful isomers from a pharmaceutical feedstock plant, or other commercially grown organism, providing directed, concentrated benefits and reduced side effects.

It is another object of the present invention to provide a linkage mapping process which allows for the production of medicines and other chemical compounds of high potency and purity from both botanical organisms.

It is yet another object of the present invention to provide a linkage mapping process which allows for the rapid and accurate directed design and production of new hybrid organisms incorporating beneficial traits allowing lower production costs and higher yields for commercial crops like biofuels, fruits, vegetables, grains, and chemical feedstocks.

It is yet another object of the present invention to provide a linkage mapping process which allows for the accurate, programmed concentration and differentiation of desired functional traits and environmental responses, including increased tolerance to drought and other climatic and environmental extremes, as well as engineered responses to pests, diseases, and weed encroachment.

It is yet another object of the present invention to provide a linkage mapping process which allows for the directed development of botanical organism genetics with novel attributes not found in nature, including but not limited to: new flavor and nutritional profiles for botanical organism-based food and feed products; timber products with custom grains and colors, new properties of fire, insect, and moisture resistance; organisms that can grow in extremely harsh environments on other planets and convert marginal atmospheres to oxygen-rich ones allowing future human habitation, or provide other agricultural terraforming applications; textiles, rope, and fiber products with various beneficial functional advantages: like improved absorption and wicking, greater insulation, strength/durability, appearance; moisture resistance, and anti-microbial action.

These and other objects and advantages of the present invention will become apparent from a reading of the attached specification and appended claims.

### SUMMARY OF THE INVENTION

The present invention is a linkage mapping process to characterize patterns in genetic code that will allow accurate functional modification to improve botanical organisms like botanical organisms, algae, fungi, molds, bacteria, and yeasts for agricultural, commercial, and industrial applications. The process initially involves molecular analysis of their analyte extracts at the isomeric level. This analysis is done using high performance liquid chromatography paired with infrared spectra technology. Statistical occurrences of each specific identified isomer of the extract produced by the organism are correlated with the phenotype patterns of that same organism produced through advanced genetic analysis. The genetic analysis used must produce an extremely accurate and granular pattern using a high-performance gene sequencer. Using advanced computational image recognition and pattern matching systems, the statistical correlations of these patterns are analyzed. These first steps of the process establish an isomer-gene link and characterize these phenotype/analyte pattern relationships.

Next, targeted selective breeding or genetic modification is used to grow botanical organisms that will consistently produce a specific pre-determined mix of chemicals as their by-product that can be customized beyond the molecular level to even select for desired specific isomers of the molecules produced, introducing unparalleled levels of chemical purity and potency for isomeric-sensitive applications like pharmaceuticals and healthcare products.

For example, the process could involve production of medical cannabis plants, or other pharmacrop species like Echinacea, which produce cannabinoids. By being able to clinically test an analyte containing only specifically selected isomers, it can be determined which isomers produce certain positive and negative effects on users. The present invention allows for the genetic isolation and concentration of the selected isomers for testing to identify those isomers having the desired medical affects.

Botanical organisms are genetically modified so as to isolate the isomer or isomers having the desired functional affect, and eliminate those extraneous and undesired isomers. The analyte containing the pure, concentrated desired isomers can then be optionally separated easily as a simple extract from the bioengineered botanical organism to accurately produce safe, but very potent medicines or other commercial and industrial chemical products.

Similarly, this process can be used to characterize, and subsequently optimize, a wide variety of valuable functional botanical organism attributes, including the aforementioned analyte optimization, across a wide variety of industries and applications, from biofuels to agribusiness to chemical feedstocks to timber and wood products to terraforming. These would also include the introduction of novel traits like environmental hardiness, appearance, life cycle attributes and other responses programmed in the organism's isoform sequence,

One embodiment of the present invention is a linkage mapping process for use in the genetic modification of botanical organisms comprising the following steps: obtaining a genetic sample from an organism; obtaining an analyte sample from said organism; conducting a chemical analysis on said analyte sample using one or more of an infrared mass spectrometry machine and a high performance liquid chromatography machine so as to create a chemical analysis dataset; conducting a genetic analysis on the genetic sample using a gene sequencer machine so as to obtain a DNA and isoform pattern dataset; identifying a dynamic genome sequence are of said organism; correlating patterns of said chemical analysis dataset and said DNA and isoform pattern dataset; and building a searchable pattern library based on the correlated patterns. The linkage mapping may further include the step of determining a desired analyte mix and related phenotype patterns.

In one embodiment of the present invention, the process further includes the steps of selecting phenotype patterns to isolate the desired analyte mix to grow for functional testing; and printing or otherwise producing a genetic sequence incorporating phenotype modifications for insertion. The organism may be a plurality of organisms of the same species, specifically a non-zoological botanical species, like plants, algae, fungi, molds, yeasts, and bacteria.

In the present invention, the DNA and isoform pattern dataset include a DNA pattern dataset and a separate isoform sequence dataset overlayed with said DNA pattern dataset. In the present invention, an environmental growing conditions dataset containing environmental data of growing conditions experienced by the organism may be created, and a sample record dataset may be created containing the growing condition dataset, the chemical analysis dataset and the DNA and isoform pattern dataset.

In the present invention, the step of correlating patterns may be conducted with an artificial intelligence system. The artificial intelligence system may utilize RBF non-linear classifier technology.

In the present invention, preferably the chemical analysis is conducted at an isomeric level.

The present invention is also a process for identifying genetic code for functional botanical organism attributes including the following steps: obtaining a genetic sample from an organism; obtaining an analyte sample from the organism; conducting a chemical analysis on the analyte sample using one or more of an infrared mass spectrometry machine and a high performance liquid chromatography machine so as to create a chemical analysis dataset; conducting a genetic analysis on the genetic sample using a gene sequencer machine so as to obtain a DNA dataset and an isoform pattern dataset; creating a growing condition dataset containing environmental conditions data of the organism; creating a sample record dataset comprising the chemical analysis dataset and the DNA dataset and the isoform pattern dataset and the growing condition dataset; identifying a dynamic genome sequence area of the organism; correlating patterns of the sample record dataset; and building a searchable pattern library based on the correlated patterns. The searchable pattern library is utilized to create a genetic sequence suitable for producing a desired isomer and corresponding functional attribute.

The present invention is also a process for creating a botanical organism having a desirable functional attribute including the following steps: obtaining genetic samples from a plurality of organisms of the same species; obtaining analyte samples from the plurality of organisms; conducting a chemical analysis on the analyte samples using one or more of an infrared mass spectrometry machine and a high performance liquid chromatography machine so as to create a chemical analysis dataset, the chemical analysis dataset comprising makeup of the organisms at an isomeric level; conducting a genetic analysis on the genetic samples using a gene sequencer machine so as to obtain a DNA and isoform pattern dataset; identifying a dynamic genome sequence are of said organism; correlating patterns of the chemical analysis dataset and the DNA and isoform pattern dataset; building a searchable pattern library based on the correlated patterns; determining a desired analyte mix and related phenotype patterns; selecting phenotype patterns to isolate desired analyte to grow for functional testing; and printing a genetic sequence incorporating phenotype modifications for insertion or other methods of genetic modification.

The foregoing Section is intended to describe, in generality, the preferred embodiment of the present invention. It is understood that modifications to this preferred embodiment can be made within the scope of the present invention. As such, this Section should not to be construed, in any way, as limiting of the scope of the present invention.

Technologies are described for processing devices and organism development systems that employ neuromorphic processing to develop new biological organisms having sought-for traits.

A processing device includes storage configured to store a usage data set and trained neuromorphic configuration data, wherein: the usage data set includes multiple organism entries that each correspond to one of multiple organisms; each organism entry includes trait data indicative of at least one trait of the corresponding organism, and biological data indicative of a genome or an epigenome of the corresponding organism; and the trained neuromorphic configuration data includes multiple trained parameters indicative of training of a neural network with at least a portion of the usage data set. The processing device also includes at least one neuromorphic device including multiple sets of hardware components, wherein: each set of hardware components is configured to store at least one trained parameter of the multiple trained parameters to implement an artificial neuron of multiple artificial neurons of the neural network; and the neural network is configured by at least the portion of the trained neuromorphic configuration data to derive a proposed genome or a proposed epigenome of a new organism based on a sought-for trait provided to inputs of the at least one neuromorphic device. The processing device further includes a processor coupled to the storage and to the at least one neuromorphic device, wherein the processor is configured to train the neural network with at least the portion of the usage data set and generate the trained neuromorphic configuration data, wherein for each organism entry of the usage data set, the processor performs operations including: provide the trait data to the inputs of the at least one neuromorphic device; and provide the biological data to outputs of the at least one neuromorphic device. The processor is also configured to use the neural network to develop the new organism, wherein the processor performs operations including: receive an indication of the sought-for trait that the new organism is meant to have from an input device coupled to the processor; provide the sought-for trait to the inputs of the at least one neuromorphic device; retrieve, from the outputs of the at least one neuromorphic device, the proposed genome or the proposed epigenome of the new organism derived by the neural network; and transmit the proposed genome or the proposed epigenome derived by the neural network to a printing device to enable generation of genetic or epigenetic material of the new organism.

An organism development system includes at least one neuromorphic device including multiple sets of hardware components, wherein: each set of hardware components is configured to store at least one trained parameter of trained neuromorphic configuration data to implement an artificial neuron of a neural network; the neural network is configured by the trained neuromorphic configuration data to derive and provide at outputs of the at least one neuromorphic device a proposed genome or a proposed epigenome of a new organism that is meant to have a sought-for trait provided to inputs of the at least one neuromorphic device; the trained neuromorphic configuration data is generated by the neural network during training of the neural network with at least a portion of a usage data set, wherein the usage data set includes multiple organism entries, and each organism entry includes trait data indicative of at least one trait of a corresponding organism, and biological data indicative of a genome or an epigenome of the corresponding organism. The organism development system also includes: a genome/epigenome printing device configured to print genetic or epigenetic material of the new organism to enable generation of the new organism based on the proposed genome or epigenome, respectively; and a trait detection device configured to detect an observed trait of the new organism following at least the generation of the new organism.

A computer-implemented method includes: receiving, at a processor, an indication of a sought-for trait of a new organism from an input device, and providing the sought-for trait to inputs of at least one neuromorphic device coupled to the processor, wherein: the at least one neuromorphic device comprises multiple sets of hardware components; each set of hardware components is configured to store at least one trained parameter of multiple trained parameters of trained neuromorphic configuration data to implement an artificial neuron of multiple artificial neurons of a neural network; and the neural network is configured by at least a portion of the trained neuromorphic configuration data to derive and provide at outputs of the at least one neuromorphic device a proposed genome or a proposed epigenome of the new organism based on the sought-for trait provided to inputs. The method also includes: retrieving, from the outputs of the at least one neuromorphic device, the proposed genome or the proposed epigenome of the new organism derived by the neural network, transmitting the proposed genome or the proposed epigenome derived by the neural network to a printing device to enable generation of genetic or epigenetic material of the new organism, and generating a new organism entry in a usage data set, wherein: the usage data set comprises multiple organism entries, and each organism entry comprises trait data indicative of at least one trait of a corresponding organism, and biological data indicative of a genome or an epigenome of the corresponding organism. The method further includes: following generation and cultivation of the new organism, operating a trait detection device to detect an observed trait of the new organism or of a derivative of the new organism; storing an indication of the observed trait as the trait data within the new organism within the new organism entry; and using at least the new entry to further train the neural network.

### BRIEF DESCRIPTION OF THE DRAWINGS

FIG. 1 shows aspects of a process for developing an organism.

FIGS. 2A and 2B, collectively referred to herein as FIG. 2, show aspects of a system for developing a biological organism having one or more sought-for traits.

FIGS. 3A and 3B, collectively referred to herein as FIG. 3, show aspects of a neural network used in developing a biological organism.

FIGS. 4A and 4B, collectively referred to herein as FIG. 4, show aspects of training the neural network of FIG. 3 for use in developing a biological organism.

FIGS. 5A, 5B, 5C and 5D, collectively referred to herein as FIG. 5, show aspects of using the neural network of FIG. 3 to develop a biological organism.

FIG. 6 shows aspects of printing genetic and/or epigenetic material of a biological organism.

FIG. 7 shows aspects of controlling a cultivation environment of a biological organism.

FIG. 8 shows aspects of monitoring a cultivation environment of a biological organism.

FIGS. 9A and 9B, collectively referred to herein as FIG. 9, shows aspects of alternate approaches to detecting observed traits of a biological organism.

FIG. 10 shows aspects of detecting a genome and/or epigenome of a biological organism.

FIG. 11 shows aspects of preparing the system of FIG. 2 for use in developing a biological organism.

FIGS. 12A, 12B and 12C, collectively referred to herein as FIG. 12, show aspects of the operation of the system of FIG. 2 to develop an organism.

### DETAILED DESCRIPTION OF THE INVENTION

In the following detailed description, reference is made to the accompanying drawings that form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

Disclosed herein is a processing device to employ neuromorphic processing in developing biological organisms. Generally, the processing device includes storage configured to store a usage data set and trained neuromorphic configuration data, wherein: the usage data set includes multiple organism entries that each correspond to one of multiple organisms; each organism entry includes trait data indicative of at least one trait of the corresponding organism, and biological data indicative of a genome or an epigenome of the corresponding organism; and the trained neuromorphic configuration data includes multiple trained parameters indicative of training of a neural network with at least a portion of the usage data set. The processing device also includes at least one neuromorphic device including multiple sets of hardware components, wherein: each set of hardware components is configured to store at least one trained parameter of the multiple trained parameters to implement an artificial neuron of multiple artificial neurons of the neural network; and the neural network is configured by at least the portion of the trained neuromorphic configuration data to derive a proposed genome or a proposed epigenome of a new organism based on a sought-for trait provided to inputs of the at least one neuromorphic device. The processing device further includes a processor coupled to the storage and to the at least one neuromorphic device, wherein the processor is configured to train the neural network with at least the portion of the usage data set and generate the trained neuromorphic configuration data, wherein for each organism entry of the usage data set, the processor performs operations including: provide the trait data to the inputs of the at least one neuromorphic device; and provide the biological data to outputs of the at least one neuromorphic device. The processor is also configured to use the neural network to develop the new organism, wherein the processor performs operations including: receive an indication of the sought-for trait that the new organism is meant to have from an input device coupled to the processor; provide the sought-for trait to the inputs of the at least one neuromorphic device; retrieve, from the outputs of the at least one neuromorphic device, the proposed genome or the proposed epigenome of the new organism derived by the neural network; and transmit the proposed genome or the proposed epigenome derived by the neural network to a printing device to enable generation of genetic or epigenetic material of the new organism.

Selective breeding, and more recently induced genetic modification, has produced a variety of important functional improvements across a wide range of botanical species grown for commercial, agricultural, and industrial purposes. The approach to accomplish this uses a largely trial-and-error methodology whereby large botanical organism populations are monitored, with or without techniques to accelerate genetic mutations, for functionally improved, useful traits. This essentially random process is very time-consuming and labor intensive, and because of that, very costly. It is also very inaccurate, and for that reason some of these processes may pose potential dangers for contamination of adjacent food crop production and thereby could pose a danger to public health.

This linkage mapping process for developing function genetic improvements in commercially grown botanical organisms of the present invention attempts to solve this problem, and is composed of five essential steps.

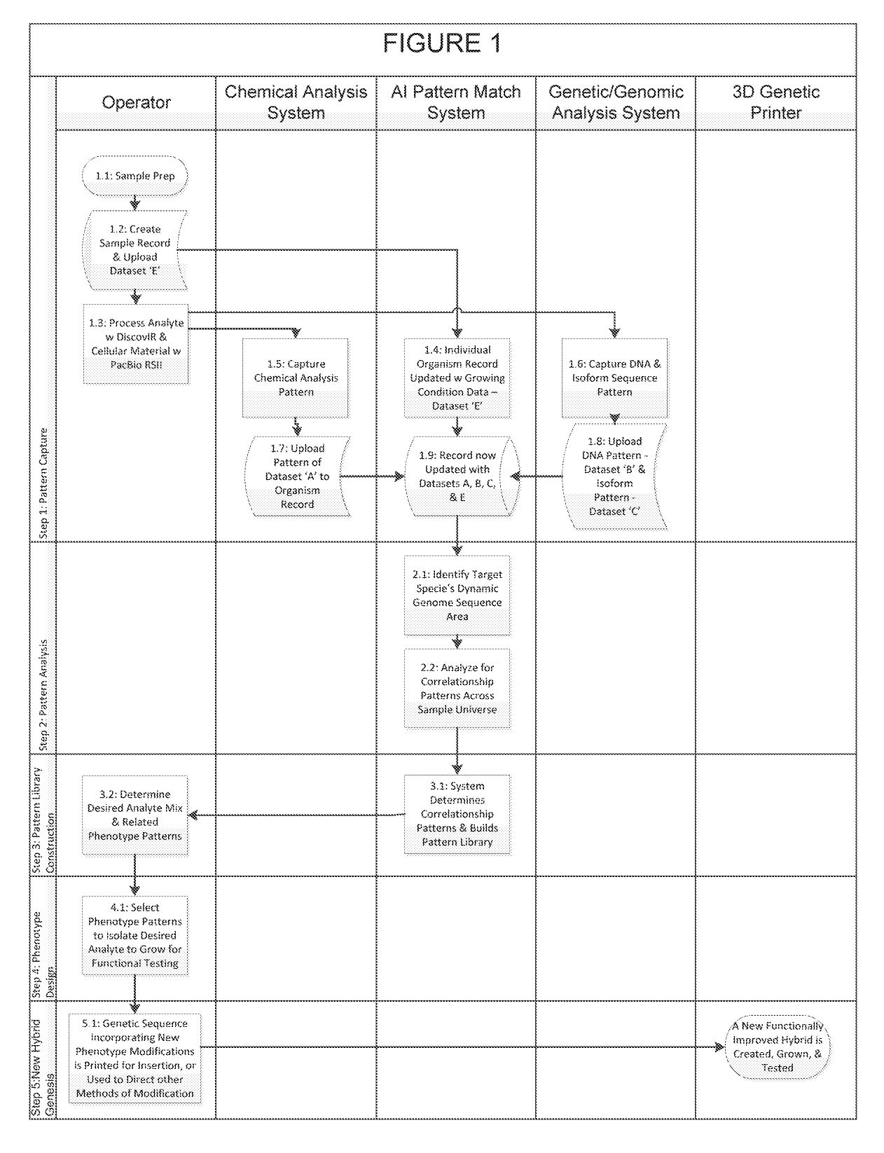

Referring to FIG. 1, Step One of the process is Pattern Capture. In Step 1.1, both analyte and genetic material samples are taken from a statistically relevant number of individual organisms of the target species to be genetically mapped for functional properties. Preferably, the organism is a non-zoological botanical organism like algae, fungi, plants, bacteria, molds, or yeasts.

A unique sample record is created in the database in Step 1.2 for each organism being sampled. To map only the DNA phenotypes, and not the isoform sequence including transcriptome annotations and assemblies that determine each organism's programmed environmental responses, the sample organisms will be grown with identical environmental conditions to remove that as a variable and only the DNA sequence, Dataset ‘B’, would be required as the genetic pattern to match.

Alternatively, if the sampled organisms are grown under a variety of monitored and logged environmental conditions, these are uploaded during this step, and a more complex pattern can be utilized that will account for, and incorporate the botanical organisms genetically programmed environmental responses as well.

This is done by adding the functional genomics analysis pattern of its full RNA transcript analysis, or isoform sequence pattern, Dataset ‘C’, as an overlay to the DNA sequence, Dataset ‘B’, and using that combined pattern, Dataset ‘D’, as the genetic profile pattern that incorporates both its DNA sequence and its RNA and mRNA transcriptome, defining its functional genomic characteristics, and thereby determining its response to environmental conditions. These patterns, when analyzed, will exhibit specific and unique patterns describing that organism in both genetic and isoform sequence analysis results. These patterns are like blueprints, one identifying the genetic code that fully defines and describes that organism, and the other completely describing the organism's programmed environmental response mechanisms.

The isomeric-level quantitative chemical analysis of the analyte extracted from the target botanical organism is carried out in Steps 1.3 and 1.5 by using a combination of IRMS (infrared mass spectrometry) and High Performance Liquid Chromatography such as the DiscovIR Test Station mentioned hereinabove. This technology allows for identification of the various isomers of chemical molecules produced as a by-product of the organism.

Concurrently, in Step 1.4, the relevant monitored environmental growing condition history experienced by the organism, Dataset ‘E’, is uploaded to the Sample Record.

At that same time in Step 1.5, an isomer library searching program, is built using the results of the isomeric analysis of Step 1.3 identifying the isomeric makeup of the by-products produced by each of the plurality of strains of the individual organisms. This allows for the automated identification of each specific isomer present in the analyte, or analytes.

This chemical analysis system is generally used to determine the presence or absence of a specific isomer within a complex organic compound, most commonly looking for a toxic or illegal substance, or one that might indicate a point-of-failure for troubleshooting purposes, but we will use the entire pattern, Dataset ‘A’, as a digital, isomeric-level, unique chemical profile pattern that fully describes and defines the entire targeted portion of the chemical by-product extract taken from the sample organism.

In Step 1.6, the genetic and genomic analysis portion of the first step, which can be carried out simultaneously with Steps 1.4 and 1.5, involves genetic testing of the plurality of strains of each targeted botanical organisms genetic material. The genetic analysis is carried out by a gene sequencer like the Pacific Biosciences PacBio RSII, and the resulting DNA sequence pattern is recorded, Dataset ‘B’. It is essential that the genetic analysis used must provide near 100% accuracy, have the ability to do single molecule reads, and if environmental growing condition variables are involved, it must also have isoform sequencing capabilities.

Dataset ‘B’ describes the individual DNA sequence of each sample taken from the plurality of strains of the target species. The sampled organism's resulting DNA sequence pattern contains the genetic code necessary to re-create, or clone, itself. Common usage of this technology allows detection of the presence or absence of specific phenotypes for a variety of applications, including medical diagnostics, is also often used as a total pattern, but only to match forensic DNA for identification purposes. Rather than using this sequence data to search for a specific gene for diagnostic purposes or as a genetic fingerprint for identification, we use the entire DNA sequence pattern as a ‘cloning blueprint’ that describes how to build that botanical organism.

Dataset ‘C’ is the pattern that represents the functional genomic sequence of the botanical organism, also known as its isoform sequence, recording it's RNA/mRNA transcriptome's assemblies and annotations, and it can also be produced at that same time during Step 1.6, by the PacBio RSII, or similarly-capable genetic sequencer, to characterize the genomic patterns in the botanical organism's RNA and mRNA transcriptome that define its response to a variety of environmental variables, including soil conditions, rainfall, sunlight, heat/cold, and resistance to disease and pests. This pattern, Dataset ‘C’, used as an overlay to the DNA sequence pattern, Dataset ‘B’, accounts for the botanical organisms responses to its environmental conditions, and is particularly useful when the sample organisms are not grown in a controlled static environment.

In Step 1.7, the Chemical Analysis Pattern, Dataset ‘A’, produced from the extracted analyte, or analytes, is uploaded to its specific Sample Record field.

Concurrently, the DNA Sequence Pattern, Dataset ‘B’, and the Isoform Sequence Pattern, Dataset ‘C’, are uploaded to their specific Sample Record fields.

If environmental growing condition variables are available and being used, Dataset ‘B’ and Dataset Pattern ‘C’ are combined as overlays and used as the Genetic Analysis Pattern, Dataset Pattern ‘D’, in comparison with the Chemical Analysis Pattern ‘A’ for that organism.

By Step 1.9, the organism's Chemical and Genetic Patterns have been captured and its Sample Record is complete. It's now time to identify the target species sequence portions that change from individual to individual within that species, and characterize those relationships.

In Step Two, Pattern Analysis, we begin the preliminary process necessary to characterize the linkage(s) between phenotype patterns and the resulting analyte(s) produced, or other functional abilities the phenotype pattern in question determines. Using pattern matching and network inference technology of artificial intelligence systems like one based on the RBF non-linear classifier technology of CogniMem CM1K ASIC, we will compare how each individual botanical organism sample's genetic analysis pattern and its quantitative chemical analysis pattern correlate with each other across a large number of samples taken within that botanical organism species. We begin by identifying the area of the genome that changes from individual sample to sample within that species, and focus on pattern correlations within that dynamic area of the genome.

In Step 2.1, we compare all the Genetic Patterns observed across all Datasets ‘D’ (or ‘B’ without environmental variables) with each other, and identify that dynamic portion of the genetic code that changes from individual to individual within the species' genome, and also compile an inventory of observed molecules and their isomers that are potentially found as analytes in the extracts of their by-products within the target species, and select those of interest for development.

Focusing on these areas of interest within these two patterns, in Step 2.2, we compare and analyze for potential relationships between the Genetic and Chemical Analysis Patterns for each individual botanical organism tested. Using a combination of advanced computational processes, including the aforementioned high-performance, advanced classifier technology running Boolean, Bayesian, and network inference approaches to provide image recognition, pattern matching, and statistical analysis of their occurrences in the observed sample universe, the system develops the ability to characterize the relationship between the observed genetic and chemical patterns. This computer analysis of the correlation of how each botanical organism samples phenotype pattern and analyte pattern occurs across a statistically relevant sampling of the target species for a large enough universe of that botanical organism's available varieties to allow each distinct isomer that is possible for that botanical organism to produce to be associated with the specific genetic phenotype that determined the botanical organism's production of that isomer.

In the Third Step of the process, Pattern Library Construction, we use these pattern correlations in Step 3.1 to construct a database library of phenotype patterns and characterize how they determine chemical by-product and other functional attributes within the target species as observed in nature. When a phenotype/isomer association is identified its characteristics are saved to the genome's database in a Pattern Library in Step 3.1, so it can be automatically identified and described by the system the next time it is encountered. With the chemically functional DNA phenotype patterns identified and understood, we can also incorporate the isoform sequence pattern as an overlay to understand and design functional improvements to the botanical organism's genomic transcriptome that determine the botanical organism's responses to environmental conditions.

In Step 3.2, the desired by-product output or other desired functional characteristic is determined from those possible options available, either phenotype patterns with desirable functional features captured from within the identified functional phenotype pattern library of that sampled organism's mapped genome, or optionally, a phenotype pattern captured from another species with observed desirable functional features can be added to the target organism's genome.

In the Fourth Step of the process, Phenotype Design, the desired functional capabilities can be programmed into the new genome by digitally combining the phenotype patterns with the best functional attributes. With a new digitally bioengineered organism now constructed and saved to digital storage, we can proceed to generation of the physical organism.

In the Fifth Step of the process, New Hybrid Genesis, the newly designed organism is created using one of several common genetic modification techniques. Or, alternately this knowledge can be used to direct selective breeding campaigns. In the preferred embodiment, with the emergence of new 3D DNA printing, an optimized genome with any customized mix of attributes would simply be selected from the attributes possible within that species, and then printed on a 3D DNA Printer. This new genetic material can be inserted using one of the aforementioned techniques, including the use of agrobacteria used to modify dicotyledonous plants, or one of the other aforementioned means of inserting genetic constructs into a target organism.

In the case of pharmaceutical development, once the isomers have been identified and isolated, an additional step of the process can proceed. In the additional step of the pharmacrop development process, organisms are first genetically modified to isolate and concentrate specific targeted isomers for clinical testing to determine which ones are therapeutically effective in order to determine the exact desired mix of medically-effective isomers of the active molecule(s), while excluding those that dilute the medication or produce unwanted side effects. Once the desired medically effective mix of isomers of the molecule(s) is determined, the organism's genetics can be modified to produce a new hybrid organism that will produce that specific chemical mix as a life-cycle by-product.

By understanding how the phenotype pattern determines the production of each isomer, the process of the present invention allows for targeted selective breeding within a single growing cycle. The present invention also allows for identifying, understanding, and then inserting those phenotypes determined to produce the specific isomer(s) desired, and removing those phenotypes that produce an isomer that either dilutes the medicinal effect by blocking the necessary receptor or worse, produces one or more unwanted side effects.

Many commercial food crops, along with some pharmacrops like cannabis, are dicotyledonous. This allows the use of an agrobacteria approach in the final step, instead of the much more expensive proton gun technique, for genetic modification. By incorporating this invention's ability to characterize the phenotype that determines the desired functional attributes of an organism, there is no need for the currently common, cumbersome techniques like Marker Assisted Selection used by today's agribusiness companies engaging in genetic modification for pest-resistant, pesticide-resistant, herbicide-resistant, or similar functional traits.

Emerging technologies in 3D DNA printing like those mentioned earlier will allow the digitally improved genetics resulting from this invention to be simply printed, which will make this invention very easy and inexpensive to incorporate into existing genetic development programs.

The present invention allows for the introduction of the desired phenotypes directly into new hybrid strains of all commercially grown botanical organisms, and thereby isolate, concentrate and as desired, couple commercially valuable custom effects and functional improvements within organisms very quickly and accurately. A hybrid organism created can offer novel attributes for commercial and industrial uses not commonly found in that species.

It can also incorporate functional genomic programming of the genomic assembly and annotation process using the new third-generation isoform sequence analysis capabilities, so it will also provide for the understanding, and subsequent re-engineering of a botanical organism's functional genome such that an organism's response to environmental conditions can also be controlled, providing improved response to soil, light, temperature, and drought conditions, automating responses like producing their own natural pesticides and herbicides when needed, or even programming it to recognize a pest species attacking it and release the specific pheromone that will attract the natural predators of that pest.

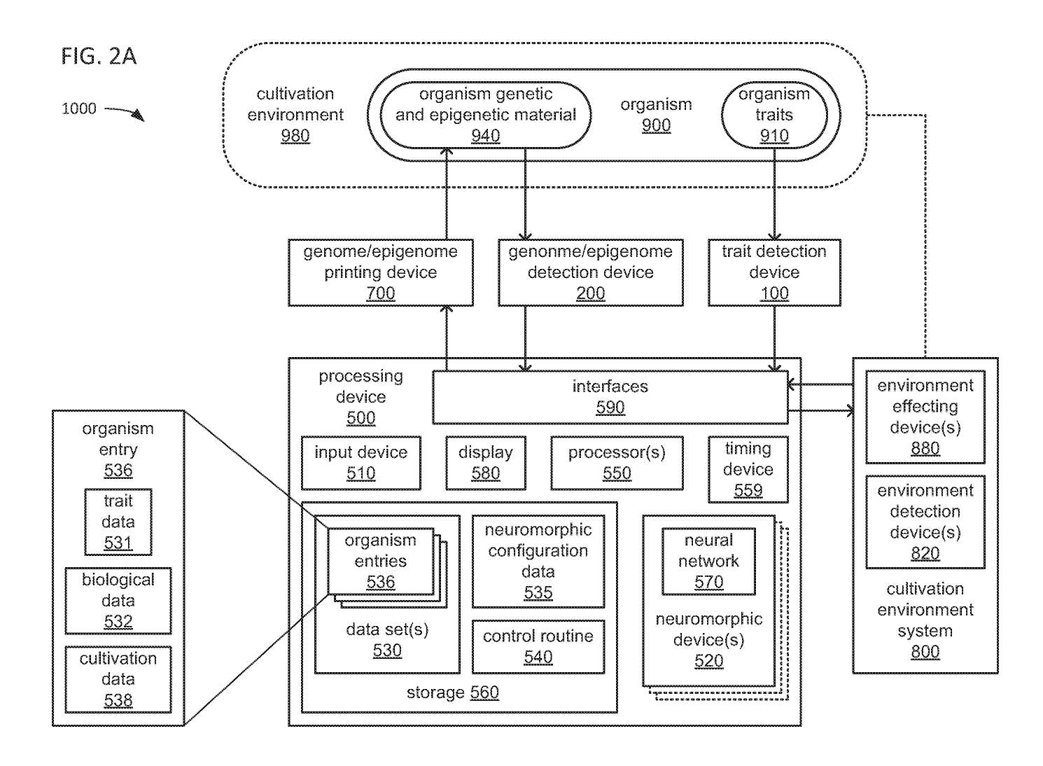

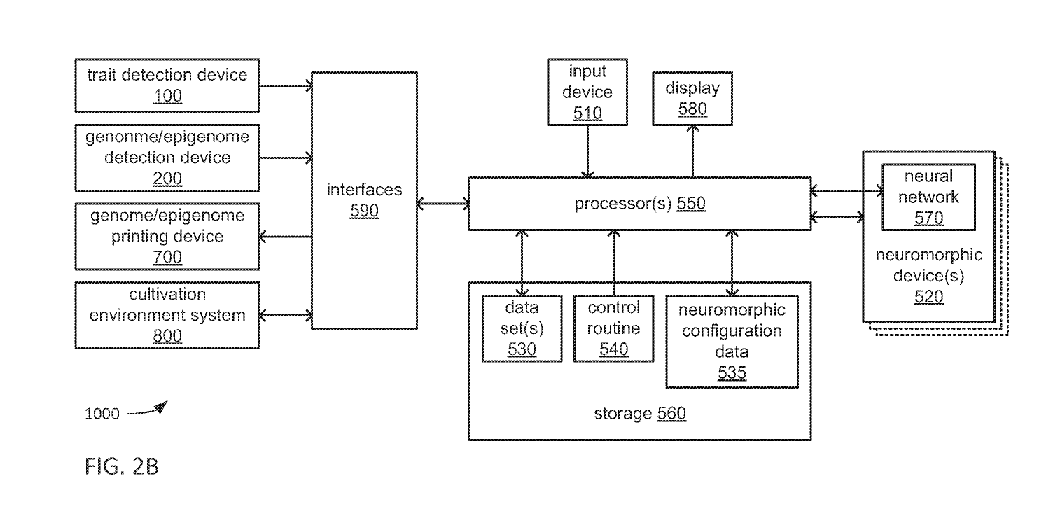

FIG. 2 depicts aspects of an organism development system 1000 configured for use in developing a biological organism 900. The organism development system 1000 may include one or more of a processing device 500, a trait detection device 100, a genome/epigenome detection device 200, a genome/epigenome printing device 700 and a cultivation environment system 800. The processing device 500 may be communicatively coupled to each of the devices 100, 200, 700 and 800 by any of a variety of electrical, optical and/or radio frequency (RF) forms of wireless and/or cabling-based connections by which the processing device 500 may control and/or monitor each of these devices. Also, as will be explained in greater detail, the processing device 500 may operate each of these devices as part of effecting the development of the biological organism 900.

The processing device 500 may incorporate an input device 510, a display 580, one or more processors 550, one or more neuromorphic devices 520, a storage 560, a timing device 559, and/or one or more interfaces 590 by which the processing device 500 may be coupled to each of the devices 100, 200, 700 and/or 800 via wireless and/or cabling-based communications. The storage 560 may store one or more data sets 530, neuromorphic configuration data 535, and/or a control routine 540. Each of the one or more data sets 530 may include numerous organism entries 536 that may each store various pieces of information about a different biological organism, including and not limited to, a genome and/or an epigenome (e.g., the depicted biological data 532), cultivation environment conditions (e.g., the depicted cultivation data 538), observed traits (e.g., the depicted trait data 531), etc. The traits indicated within each organism entry 536 may encompass any of a variety of characteristics of an organism, including and not limited to color, shape, size, physical structure, taste, growth rate, life cycle, development milestones, resistance and/or response to various adverse environmental conditions (e.g., pests, disease, physical impacts, exposure to particular chemicals), production of particular chemical compounds (e.g., excretions), reproduction capability, etc.

Within the processing device 500, non-neuromorphic processing may be employed in controlling the overall operation of the organism development system 1000. More specifically, the control routine 540 may incorporate a sequence of instructions operative on at least one of the one or more processors 550 to perform various functions, including the processing device 500 controlling, monitoring and exchanging data with, each of the devices 100, 200,700 and 800. Additionally, non-neuromorphic processing by the one or more processor 550 may be employed in providing a user interface (UI) by which various aspects of the operation of the organism development system 1000 and/or of the processing device 500 may be configured. By way of example, the processing device 500 may require some amount of configuring, with input from an operator via the UI, to establish wireless and/or cabling-based communications between the processing device 500 and each of the other devices 100, 200, 700 and/or 800. Also by way of example, such provision of the UI may enable an operator to control aspects of the preparation of the processing device 500 for use in developing a biological organism, including selection of a data set 530 for use as training data to train the neural network 570. Further, training data for individual biological organisms and/or indications of sought-for traits may be provided as input to the processing device 500 through the UI, and/or indications of the probability of success in developing a biological organism having those sought-for traits and/or other related information may be provided to an operator through the UI.

In contrast, and also within the processing device 500, neuromorphic processing may be employed in generating a proposed genome, a proposed epigenome and/or proposed cultivation environment conditions for a biological organism that is meant to have one or more sought-for traits. More specifically, a neural network 570 may be instantiated within the one or more neuromorphic devices 520, and the neural network 570 may be trained with one of the data sets 530 employed as training data (e.g., a data set 530 selected by an operator through the UI). In such training, the information stored within each organism entry 536 for each of multiple biological organisms may be used to train the neural network 570 to recognize various correlations among genome, epigenome, cultivation environment conditions, and/or observed traits. Following such training of the neural network 570, the neural network 570 may then be employed to derive the proposed genome, the proposed epigenome and/or the proposed cultivation environment conditions to cause the generation of a biological organism that is expected to have one or more sought-for traits.

In essence, and as most clearly depicted in FIG. 2B, the one or more processors 550 are caused, by execution of the control routine 540, to operate in a manner in which the one or more processors 550 are interposed between the one or more neuromorphic devices 520 and other devices, both within and external to the processing device. The one or more processors 550 may each be any of a wide variety of processors that are configured to perform instruction-based processing that entails the execution of sequences of instructions, including and not limited to central processing units (CPUs), graphics processing units (GPUs), microcontrollers, sequencers, etc. Each of the one or more processors 550 may be incorporate any of a variety of features to enhance speed and/or efficiency of processing operations. Such features may include and are not limited to, multi-threading support, multiple processing cores, single-instruction multiple-data (SIMD) support, directly integrated memory control functionality, and/or various modes of operation by which speed of execution of instructions may be dynamically altered.

The one or more processors 550 may serve as the processing component in an implementation of a Von Neumann architecture within the processing device 500. As reflected in FIG. 2B, in that architecture, the one or more neuromorphic devices 520 may be deemed to be co-processing devices that are “slaved” to the one or more processors 550. Although, the one or more processors 550 may be programmable with a sequence of instructions to instantiate and maintain the neural network 570, the resulting implementation of the neural network 570 would be built atop software-based simulations of the artificial neurons of the neural network 570. The sheer quantity of data that makes up the genome and epigenome of most organisms is sufficiently large that a very large quantity of artificial neurons would have to be simulated by the one or more processors 550.

Regardless of whether the one or more processor(s) 550 include CPUs, GPUs or a combination thereof, such software-based simulation of so many artificial neurons would be at least impractical, if not impossible given the current state of the art of processors that employ instruction-based processing. At best, the resulting throughput would be sufficiently low as to be too impractical for use. Among the factors that would cause such low throughput would be the fact that the parameters controlling the behavior of each of such a large quantity of artificial neurons would have to be repeatedly reloaded from random access storage at a rate that would consume all available data bus bandwidth between each processor 550 and the storage 560 as part of simulating the complex interactions that each artificial neuron would have with every other artificial neuron with which it is connected. In contrast, and as will be explained in greater detail, each of the hardware-based implementations of an artificial neuron within each of the one or more neuromorphic devices 520 directly incorporates the storage capability to store such parameters for the artificial neuron it implements such that there is no such consumption of bus bandwidth. Thus, during use of the neural network 570, each of the hardware-based implementations of an artificial neuron is able to respond independently to the input(s) it receives in parallel with at least the other artificial neurons within the same layer. The result is a level of throughput through the one or more neuromorphic devices that is multiple orders of magnitude greater than could possibly be achieved using any possible combination of CPUs and/or GPUs.

The storage 560 may be based on any of a variety of storage technologies that provide relatively high speeds of access, but which require the continuous provision of electric power to retain any data and/or routines stored therein. Such technologies may include, and are not limited to, random-access memory (RAM), dynamic RAM (DRAM), Double-Data-Rate DRAM (DDR-DRAM), synchronous DRAM (SDRAM), static RAM (SRAM), etc. Alternatively or additionally, the storage 560 may be based on any of a variety of storage technologies that may not be capable of providing such relatively high speeds of access, but which may be capable of storing with greater density, and capable of retaining data and/or routines stored therein regardless of whether electric power is continuously provided. Such technologies include, and are not limited to, read-only memory (ROM), erasable programmable ROM (EPROM), electrically erasable programmable ROM (EEPROM), flash memory, magnetic or optical cards, one or more individual ferromagnetic disk drives, or a plurality of storage devices organized into one or more arrays (e.g., multiple ferromagnetic disk drives organized into a Redundant Array of Independent Disks array, or RAID array).

Each of the individual interfaces 590 by which each of the devices 100, 200, 700, 800 and/or still other devices not specifically shown may be coupled to the processing device 500 may each employ any of a variety of wireless communications technologies, including and not limited to, radio frequency transmission, transmission incorporated into electromagnetic fields by which electric power may be wirelessly conveyed, and/or any of a variety of types of optical transmission. Additionally, each of the individual interfaces 590 may be configured to engage in communications that adhere in timings, protocols and/or in other aspects to one or more known and widely used standards, including and not limited to IEEE 802.11a, 802.11ad, 802.11ah, 802.11ax, 802.11b, 802.11g, 802.16, 802.20 (commonly referred to as “Mobile Broadband Wireless Access”); Bluetooth; ZigBee; or a cellular radiotelephone service such as GSM with General Packet Radio Service (GSM/GPRS), CDMA/1×RTT, Enhanced Data Rates for Global Evolution (EDGE), Evolution Data Only/Optimized (EV-DO), Evolution For Data and Voice (EV-DV), High Speed Downlink Packet Access (HSDPA), High Speed Uplink Packet Access (HSUPA), 4G LTE, etc.

Alternatively or additionally, each of the individual interfaces 590 may each employ any of a variety of cabling-based communications technologies by which electrical and/or optical signals may be used in to exchange information through any of a variety of electrical and/or optical cabling. Also alternatively or additionally, each of the individual interfaces 590 may be configured to engage in communications that adhere in timings, protocols and/or in other aspects to one or more known and widely used standards, including and not limited to RS-232C, RS-422, Universal Serial Bus (USB), Ethernet (IEEE-802.3) or IEEE-1394

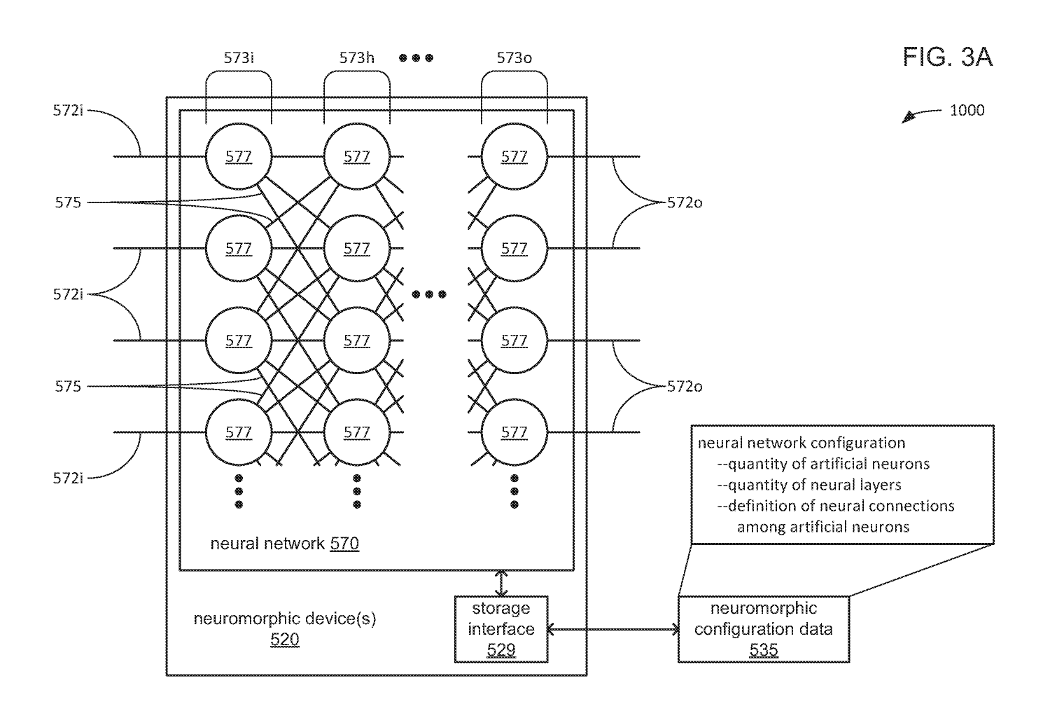

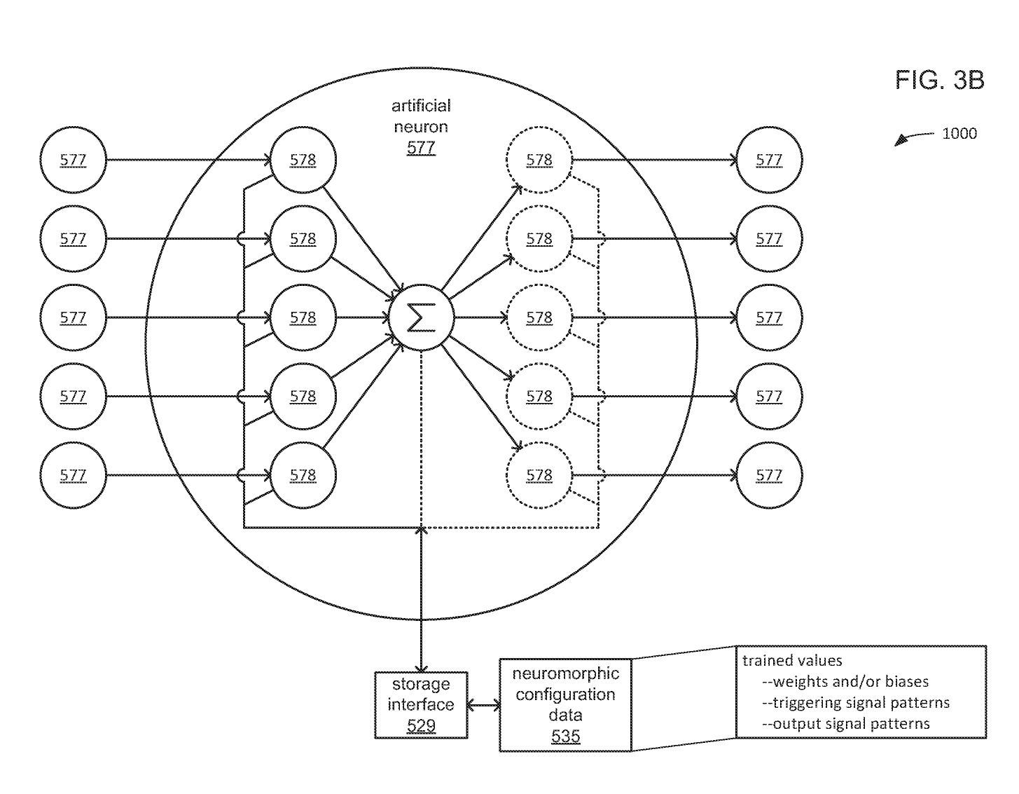

FIG. 3 depicts aspects of the internal architecture of the neural network 570 as instantiated and maintained by the one or more neuromorphic devices 520. As additionally depicted, at least one of the one or more neuromorphic devices 520 may incorporate a storage interface 529 by which the neuromorphic configuration data 535 may be provided by the one or more processors 550. Where more than one of the neuromorphic devices 520 are used, a single one of the neuromorphic devices 520 may relay some or all of the neuromorphic configuration data 535 to the others, or each of the neuromorphic devices 520 may be directly provided with at least a portion of the neuromorphic configuration data 535.

As depicted, the neural network 570 may be defined by the neuromorphic configuration data 535 to be a multi-layer feedforward form of artificial neural network (ANN). In being defined as a multi-layer ANN, the neural network 570 may be defined as having multiple inputs 572i and multiple outputs 572o between which numerous artificial neurons 577 are organized into three or more layers that include an input layer 573i, an output layer 573o, and at least one hidden layer 573h between the input layer 573i and the output layer 573o. In being defined as a feedforward ANN, the artificial neurons 577 may be interconnected with a set of connections 575 that are defined by the neuromorphic configuration data 535 to convey information solely between adjacent layers 573 in a direction extending generally from the input layer 573i and toward the output layer 573o, without any connections between artificial neurons 577 that are within the same layer 573, and without any connections that convey information in the reverse direction extending generally from the outputs 572o and the output layer 573o, and back toward the input layer 573i and the inputs 572i. More simply, all connections among the artificial neurons 257 are defined as conveying information in the “forward” direction from the inputs 572i and input layer 573i, and toward the output layer 573o and the outputs 572o, without any “crosstalk” flow of information within any of the layers 573, and without any “feedback” flow of information. Such a configuration of layers 573 of artificial neurons 577 and of connections 575 between the layers 573 is based on observations of the manner in which real neurons appear to interact within the brains of human beings and various animals, and have been used with some degree of success in mimicking the function of such parts of the human brain as the human visual system where ANNs have been used to implement visual recognition systems. However, despite this specific depiction of the neural network 570 as a multi-layer feedforward form of ANN, it should be noted that other embodiments are possible in which the neural network 570 may be defined as having a different structure in which the artificial neurons 577 may be organized differently and/or in which the connections 575 may be defined to extend among the artificial neurons 577 in a different configuration.

The neuromorphic configuration data 535 may include various hyperparameters that define various structural features of the neural network 570. By way of example, hyperparameters in the neuromorphic configuration data 535 may define the neural network 570 as a multi-layer feedforward form of ANN, may specify the total quantity of artificial neurons 577 included therein, may specify the quantity of layers 573, may specify which artificial neurons 577 are connected, and/or the direction in which information is conveyed through those connections 575.

FIG. 3B depicts aspects of an example internal architecture for the artificial neurons 577. As depicted, each of the artificial neurons 577 may incorporate multiple memristors 578, with each memristor 578 receiving an input from outside the artificial neuron 577. Where the depicted artificial neuron 577 is incorporated into the output layer 573o or into a hidden layer 573h, each of these inputs may be received from another artificial neuron 577 of another layer 573. However, where the depicted artificial neuron 577 is incorporated into the input layer 573i, each of these inputs may be one of the external inputs 572i to the neural network 570. It should be noted that, where the depicted artificial neuron 577 is incorporated into the input layer 573i, the depicted artificial neuron 577 may alternatively receive just one of the external inputs 572i to the neural network 570. The neuromorphic configuration data 535 may define weights and/or biases for each memristor 578 to control such factors as what type and/or magnitude of input each memristor 578 responds to and/or the sensitivity of each memristor 578 to the input it receives. Alternatively or additionally, the neuromorphic configuration data 535 may define input patterns that may serve to trigger the depicted artificial neuron 577, and/or the manner in which a cumulative quantity, magnitude and/or frequency of input received by each memristor 578 may serve to trigger the depicted artificial neuron 577. Regardless of what weights, biases, patterns and/or other input response parameters may be defined for each memristor 578 within the neuromorphic configuration data 535, each memristor 578 may incorporate storage component(s) that cause the memristor 578 to function at least partially as a memory storage device into which such parameters may be directly stored.

As will be familiar to those skilled in the art, the internal architecture of artificial neurons is a subject of ongoing research and development, and so other internal architectures of artificial neurons are possible. More generally, the internal architectures of neuromorphic devices is a subject of ongoing research and development, with various examples of neuromorphic devices having already been introduced with varying ranges of capability, of which the earlier described CogniMem CM1K ASIC is an example. Thus, as additionally depicted, the depicted artificial neuron 577 may employ any of a variety of forms of internal logic to combine, sum or otherwise aggregate the inputs received from other artificial neurons 577 or as external input(s) 572i to the neural network 570. As depicted in this example internal architecture, the depicted artificial neuron 577 may incorporate a relatively simple summation node to perform such a combining or other aggregation.

As also additionally depicted, the depicted artificial neuron 577 may incorporate still one or more additional memristors 578, with each such additional memristor 578 providing an output from within the artificial neuron 577 upon triggering of the artificial neuron. Where the depicted artificial neuron 577 is incorporated into the input layer 573i or into a hidden layer 573h, each of these outputs may be to another artificial neuron 577 of another layer 573. However, where the depicted artificial neuron 577 is incorporated into the output layer 573o, each of these outputs may be one of the external outputs 572o from the neural network 570. It should be noted that, where the depicted artificial neuron 577 is incorporated into the output layer 573i, the depicted artificial neuron 577 may alternatively provide just one of the external outputs 572o of the neural network 570. The neuromorphic configuration data 535 may define such factors as what type, magnitude, frequency and/or duration of output each such additional memristor 578 may provide when the depicted artificial neuron 577 is triggered. Again, each such additional memristor 578 may function at least partially as a memory storage device into which such parameters may be directly stored.

It should again be noted that the depiction of an internal architecture for the artificial neurons 577 is but one example of such an architecture, and that other internal architectures are possible in other embodiments. Additionally, the various variations of this depicted architecture that have been discussed herein are but a few examples of such variations, and other internal architectures are possible in other embodiments. By way of example, other internal architectures are possible that incorporate more or fewer memristors; incorporate alternative components to memristors; incorporate any of a variety of aggregating, combining and/or summation components; and/or incorporate any of a variety of differing quantities of inputs and outputs.

Each memristor 578 may incorporate a set of any of a variety of hardware components, including and not limited to, a combination of semiconductor components that are interconnected in a manner that implements logic causing the memristor 578 to respond to input signal(s) meeting one or more particular requirements, including and not limited to, timing, duration, voltage level, voltage polarity, level of current flow, direction of current flow, quantity and/or type of transitions, shape of waveform, quantity and/or frequency of occurrence of specific feature(s), etc. Such particular requirements may be at least partially dictated by the one or more trained parameters of an instance of the neuromorphic configuration data 535 (e.g., 535i or 535t). The variety of semiconductor components that may be used to implement such logic include, and are not limited to, discrete digital gate logic (e.g., AND, OR, NAND, NOR, XOR gates), transistors, programmable logic devices (PLDs) or portions thereof, field-programmable gate arrays (FPGAs) or portions thereof, application-specific integrated circuits (ASICs) or portions thereof, etc.

As previously discussed, each memristor 578 may incorporate local storage to store one or more of such particular requirements and/or one or more of the trained parameters. With such storage directly incorporated into each memristor 578 as part of the set of hardware components such that the storage is directly accessible to the logic implemented by the set of hardware components, again, the need to access storage located externally from the memristors 578 to retrieve such particular requirements and/or trained parameters during use of the neural network 570 is obviated, thereby contributing to the speed with which the memristor 578 are able to function. As with the storage 560, the local storage incorporated into each memristor 578 may be based on any of a variety of volatile and/or non-volatile storage technologies, as described above in reference to the storage 560.

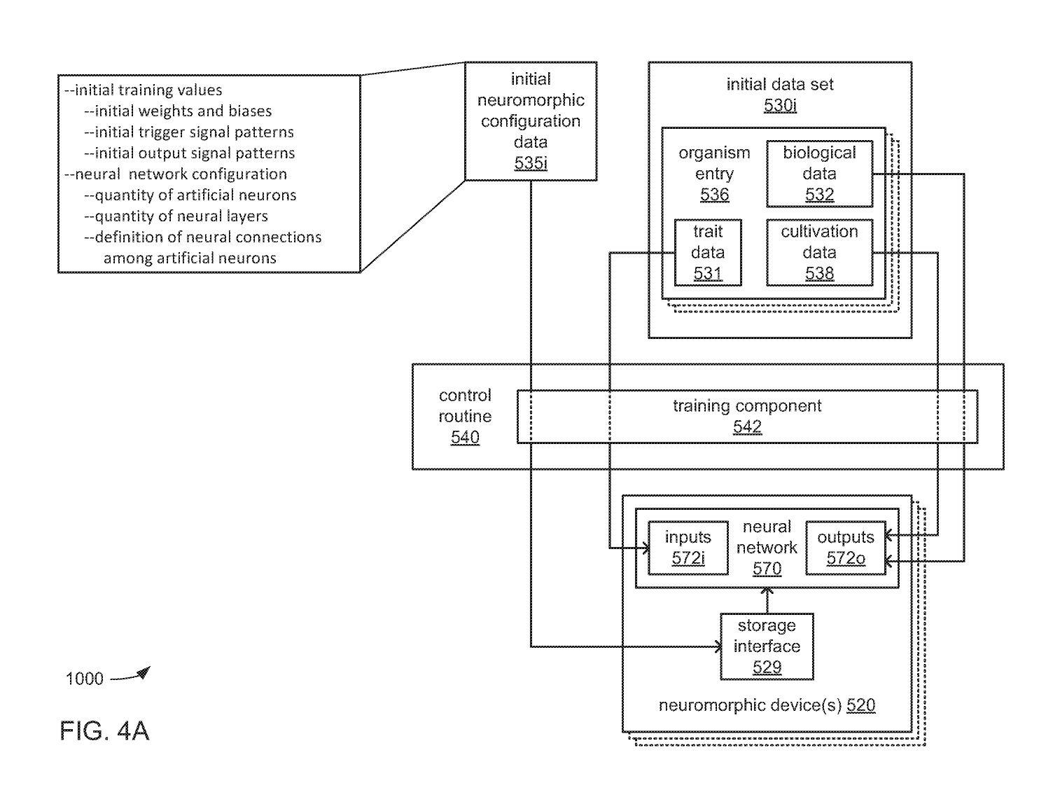

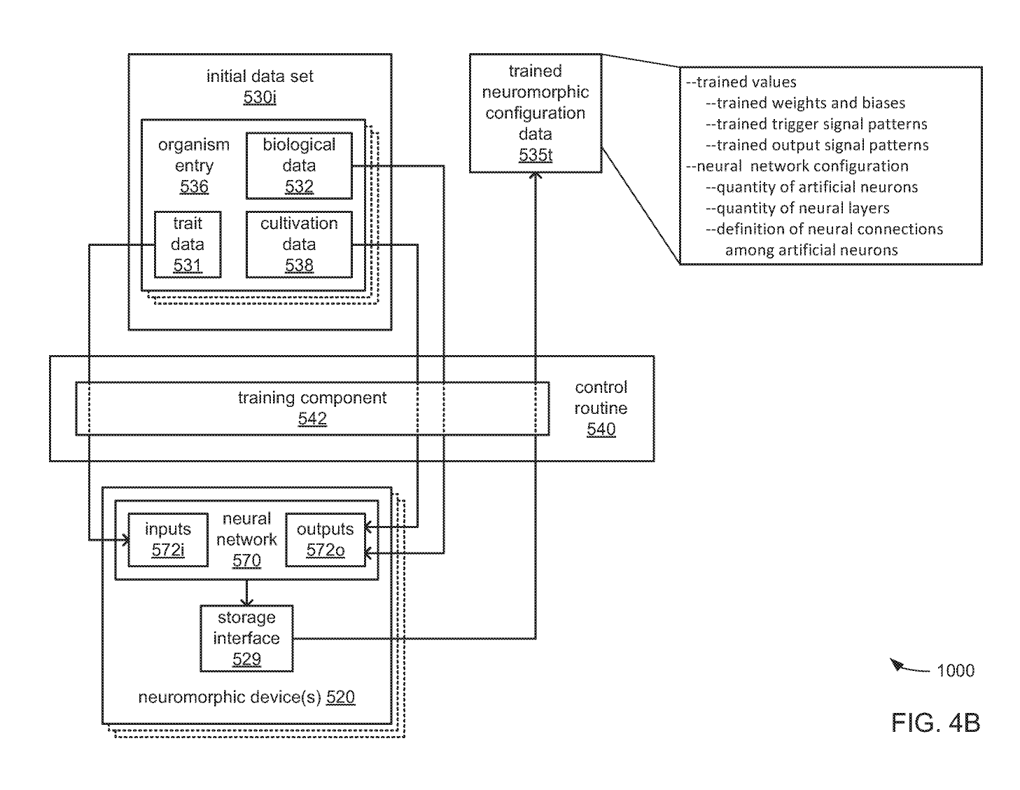

FIG. 4 depicts aspects of training the neural network 570. More specifically, the processor(s) 550 are caused by execution of the training component 542 of the control routine 540 to train the neural network 570 using an initial data set 530i made up of numerous organism entries 536 that each include a set of trait data 531, biological data 532 and/or cultivation data 538 that have been correlated to each other for a single biological organism. As depicted, for each organism entry 536 within the initial data set 530i, the trait data 531 is presented to the inputs 572i of the neural network 570, while the biological data 532 and the cultivation data 538 are presented to the outputs 572o of the neural network 570. This may be done in recognition of the manner in which the neural network 570 is intended to be used, where data indicative of one or more sought-for traits of a new organism are to be presented to the inputs 572i, and the neural network 570 is meant to respond to such input by providing data indicative of a proposed genome, a proposed epigenome and/or proposed cultivation environment conditions for the new organism at the outputs 572o.

As previously discussed, the neural network 570 may be defined as a multi-layer feedforward ANN in which information flows generally in a single direction therethrough from the inputs 572i and the input layer 573i toward the output layer 573o and the outputs 572o during use of the neural network 570. However, during training of the neural network 570, as depicted, the outputs 572o serve as additional inputs such that information flows in the reverse direction from the outputs 572o and the output layer 573o toward the input layer 573i in a part of the neural network training often referred to as “backpropagation.” In presenting a succession of matched sets from each organism entry 536 of trait data 531 to the inputs 572i and of both biological data 532 and cultivation data 538 to the outputs 572o, the neural network 570 is caused to internally derive a complex function that fits each of the correlated sets of data contained within each organism entry 536 through inference in a manner often referred to as “supervised learning.”

Such training of a neural network from such training data is often referred to as creating the “decision space” that defines what response the neural network is to provide at its output for each possible input. However, as those skilled in the art will readily recognize, it is usually not possible to train a neural network with every possible combination of inputs and outputs. This is usually due to the quantity of possible combinations of inputs and outputs being impractically or impossibly large such that not all of such combinations are able to be directly trained for. Alternatively or additionally, this may be the case where the training data used in training a neural network is necessarily limited by the limits of available knowledge, as in this case where the quantity of organism entries 536 within the initial data set 530i used to train the neural network 570 may be limited due to current limitations of what is known about existing biological organisms. Indeed, the data needed to fill even a majority of the points in the decision space of the neural network 570 may simply not exist.

As depicted most clearly in FIG. 4A, in preparation for such training, the neural network 570 may be instantiated using an initial neuromorphic configuration data 535i that may include a set of hyperparameters that define structural aspects of the neural network 570, as well as various initial parameter values that at least place the neural network 570 in a known initial state in preparation for training. Among the structural details that may be specified by the hyperparameters of the initial neuromorphic configuration data 535i may be the quantity of artificial neurons 577 to be included in the neural network 570, the quantity of layers 573 into which the artificial neurons 577 are to be organized, and/or the configuration of connections 575 among the artificial neurons 577 (e.g., which artificial neurons 577 are connected and/or the direction of flow of information through each connection 575). The initial parameters may include indications of weighting values, bias values, and/or input signal characteristics that determine the parameters of how each memristor 578 associated with an input of each artificial neuron 577 responds to that input. Alternatively or additionally, the initial parameters may include indications of output signal parameters that determine aspects of the output each of the artificial neurons 577 generates when triggered. As previously discussed, such initial parameters may be stored directly within each of the individual memristors 578 that they are associated with.

During training of the neural network 570, the initial parameters provided in the initial neuromorphic configuration data 535i and stored within the memristors 578 are replaced with trained parameters that are representative of the learned behavior of the neural network 570 and become part of the definition of the neural network 570, as trained. As depicted most clearly in FIG. 4B, following such training of the neural network 570, trained neuromorphic configuration data 535t may be retrieved from the neural network 570 and stored within the storage 560 for subsequent retrieval at times when the neural network 570 is to be used. The trained neuromorphic configuration data 535t defines the neural network 570 as trained. In addition to the set of hyperparameters that define structural aspects of the neural network 570, the trained neuromorphic configuration data 535t may also include various trained parameters such as weighting and/or bias values, and/or indications of type, magnitude, duration and/or frequency of signals that trigger each artificial neuron 577 of the neural network 570, as trained.

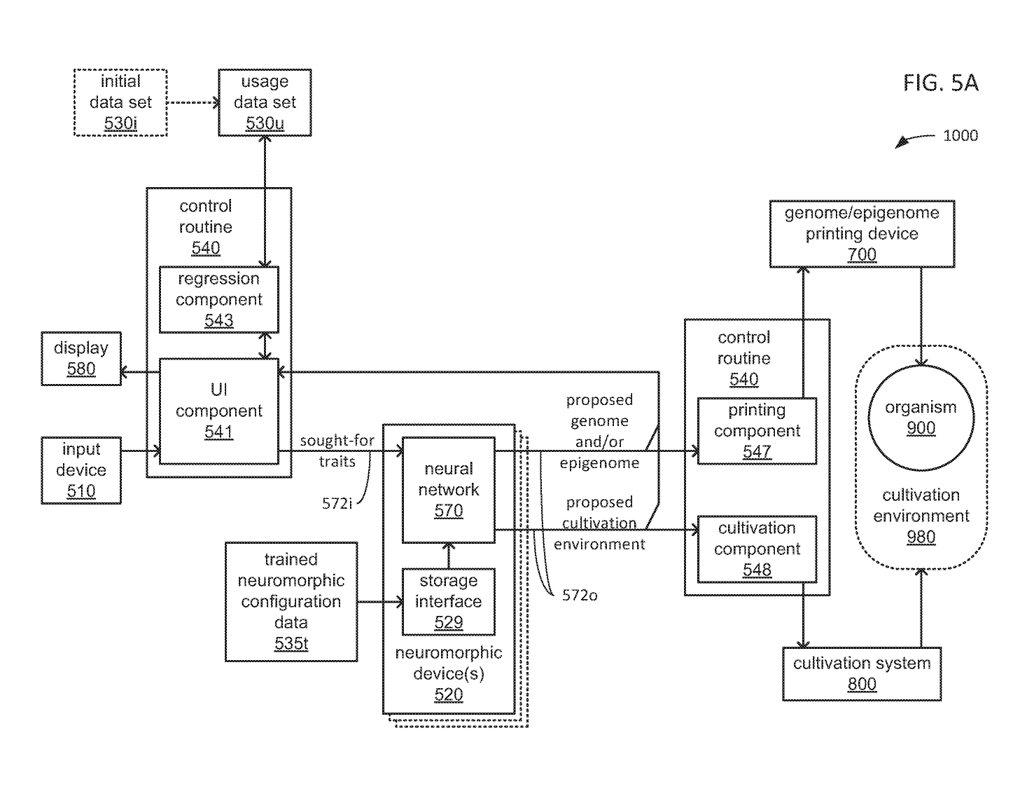

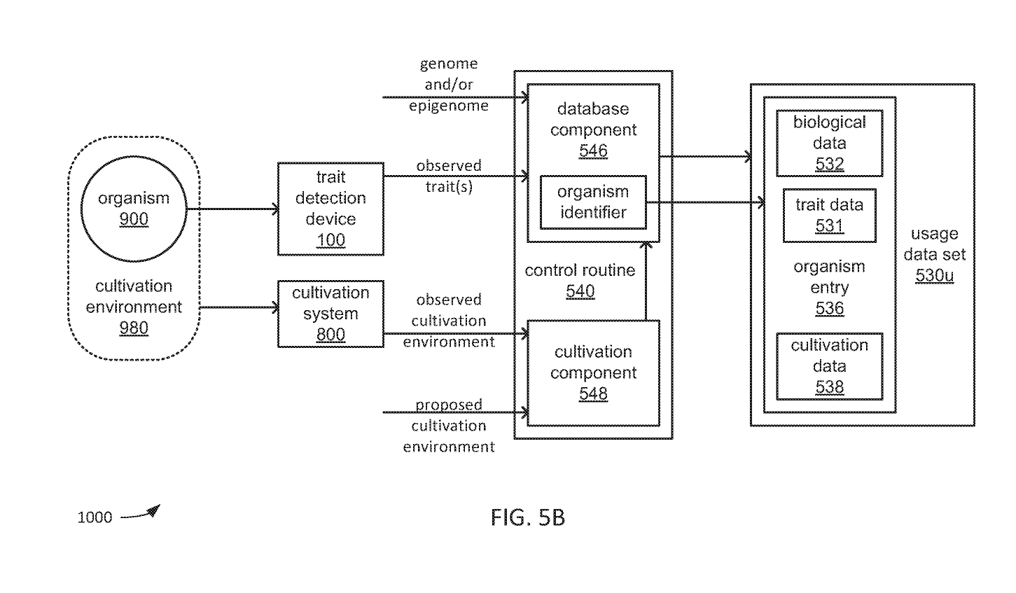

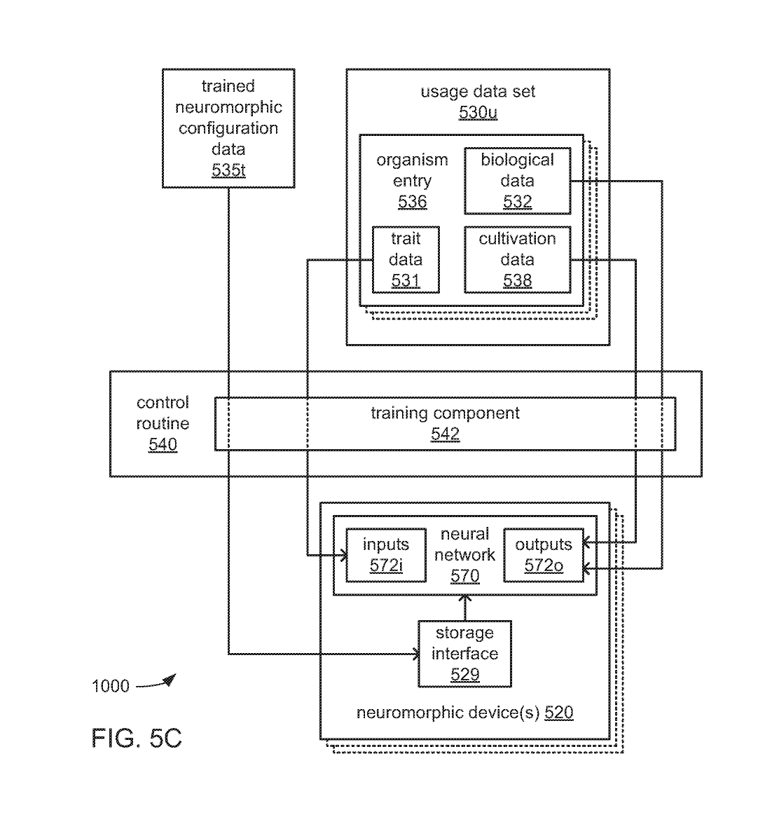

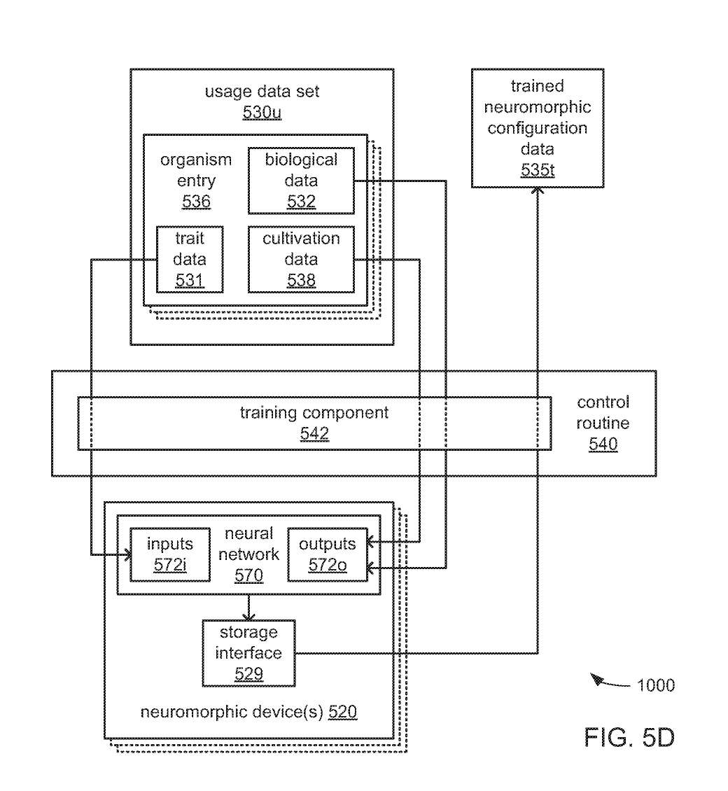

FIG. 5 depicts aspects of using the neural network 570 in developing a biological organism. More specifically, the processor(s) 550 may be caused by execution of various components of the control routine 540 to operate various components of the organism development system 1000, including the neural network 570, to perform a succession of operations to generate, cultivate and test at least one biological organism as part of developing a new biological organism that has one or more sought-for traits.

As depicted most clearly in FIG. 5A, following the training of the neural network 570 with the initial data set 530i used as the training data, the initial data set 530i may be duplicated in storage with the duplicate becoming a usage data set 530u. Although the usage data set 530u may initially be identical to the initial data set 530i, over time as new organism entries 536 are added to the usage data set 530u, the usage data set 530u may become a superset of the initial data set 530i.

In executing a UI component 541 of the control routine 540, the processor(s) 550 may be caused to receive an indication of the entry of one or more sought-for characteristics by an operator of the organism development system 1000 via the input device 510. In some embodiments, the processor(s) 541 may initially provide the indication of the sought-for traits to a regression component 543 of the control routine 540, where by the processor(s) 550 may be caused to analyze the usage data set 530u in view of the sought-for traits to derive a current statistical probability of success in generating a biological organism that will have the sought-for traits, given the contents of the organism entries currently within the usage data set 530u. The processor(s) 550 may then be caused by continued execution of the UI component 541 to present an indication of the derived statistical probability on the display 580. In so doing, the processor(s) 550 may accompany the presentation of the derived statistical probability with a request for confirmation by the operator that at least the generation of a new biological organism is to proceed, in view of the derived statistical probability. The processor(s) 550 may then delay the commencement of generating a new biological organism until such confirmation has been received through the input device 510 and/or by another mechanism.

Presuming that the generation of a new biological organism is to proceed (e.g., either confirmation was received or the request for confirmation was not presented to the operator), the processor(s) 550 may be caused to provide the one or more neuromorphic devices 520 with the trained neuromorphic configuration data 535t to enable the instantiation of the neural network 570 within the one or more neuromorphic devices 520. Also presuming that the generation of a new biological organism is to proceed, the processor(s) 550 may be caused to relay the indication of the one or more sought-for traits to the inputs 572i of the neural network 570. In response to being presented with the indication of the sought-for trait(s) at the inputs 572i, the neural network 570 employs the complex function correlating inputs to outputs that was learned during training to derive output values to present at the outputs 572o that are indicative of a proposed genome, a proposed epigenome and/or proposed cultivation environment conditions for generating a new biological organism that is expected to have the sought-for traits.

With the proposed genome, proposed epigenome and/or proposed cultivation environment conditions so derived, the processor(s) 550 may be caused to present such information to an operator of the organism development system 1000 on the display 580. Such a presentation may also be accompanied by another request for confirmation to proceed with generating the new biological organism. This may be deemed desirable to afford the operator an opportunity to review such information to determine if there are any issues that would militate against proceeding. By way of example, it may be that the proposed cultivation environment conditions are such that they cannot be provided, such as an amount of growing time that may be deemed to be too long.

Turning briefly to FIG. 5B, presuming that the generation of a new biological organism is to proceed (e.g., either confirmation was received or the request for confirmation was not presented to the operator), the processor(s) 550 may be caused to generate a new organism entry 536 within the usage data set 530u for the new organism, and may store indications of the proposed genome, the proposed epigenome and/or the proposed cultivation environment conditions for the new organism therein. In so doing, the processor(s) 550 may be caused by a database component 546 of the control routine 540 to assign a unique organism identifier to the newly generated organism entry 536 and as an identifier of the new organism, itself. As will be explained in greater detail, the information stored in such new organism entries 536 generated for each new organism that is to be generated may subsequently be used to refine the training of the neural network 570, thereby improving its function over time.

Returning to FIG. 5A, and also presuming that the generation of a new biological organism is to proceed, the processor(s) 550 may be caused by execution of a printing component 547 of the control routine 540 to relay an indication of the proposed genome and/or proposed epigenome to the genome/epigenome printing device 700 to enable the generation of genetic and/or epigenetic material as part of generating the new biological organism. The processor(s) 540 may be further caused by execution of a cultivation component 548 of the control routine 540 to relay an indication of the proposed cultivation environment conditions to the cultivation system 800 to enable the creation of that proposed cultivation environment for the purpose of growing the new biological organism.

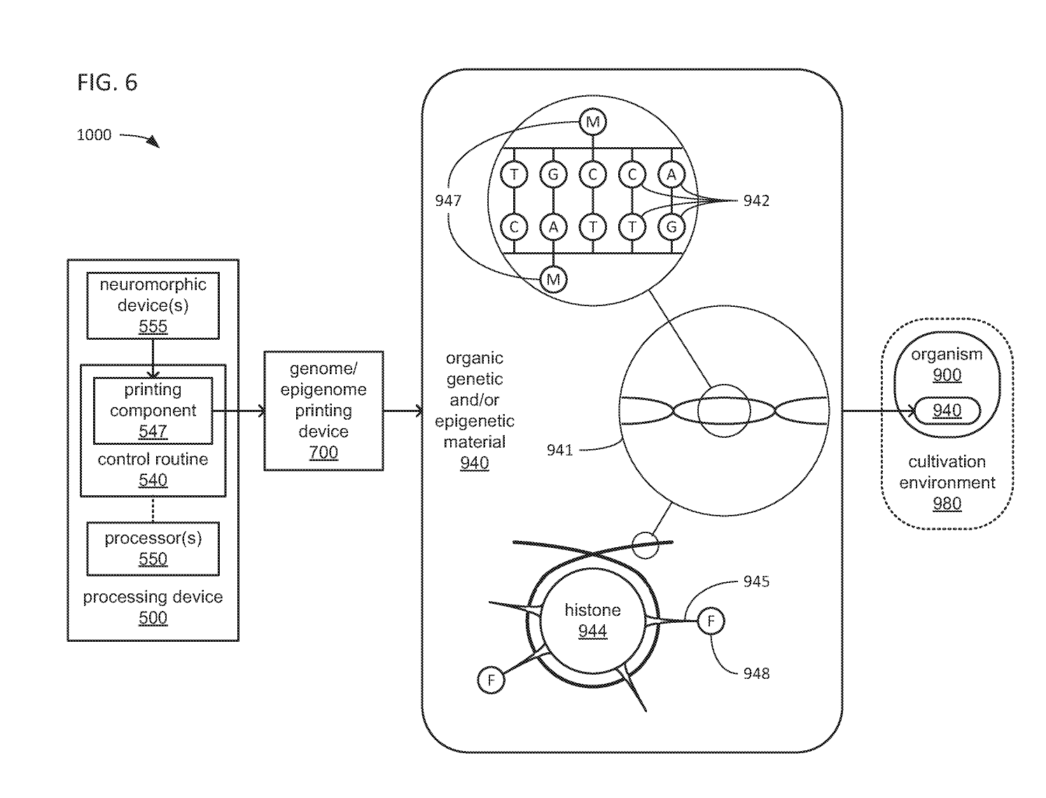

FIG. 6 depicts aspects of generating genetic and/or epigenetic material 940 of a new biological organism 900. Recent advances in the manipulation of complex molecules have enabled the introduction of devices capable “printing” genetic and/or epigenetic material, thereby further enabling the at-will generation of new genetically engineered organisms.

As will be familiar to those skilled in the art, while it was thought for many years that a genome of a biological organism represented most, if not all, of what was needed to be known to theoretically recreate that organism, there has been a more recent growing realization that the epigenome may also be needed. Recent research has lead to a growing realization that the genome provides all of the pieces of information that may be needed to create a biological organism, it is the epigenome that determines which of those pieces of information are actually used at various times and/or under various circumstances. Stated differently, the epigenome controls which genetic sequences of a genome are allowed to be “expressed” such that they are allowed to exert their influence over the activities carried out within each cell of an organism. Further, the selection of which genetic sequences are so allowed to be expressed may change over time in response to numerous influences, including the environmental conditions in which a biological organism exists.

As depicted, a DNA strand 941, which defines and is the physical manifestation of the genome of a biological organism, is made up of a double-helix of paired nucleotides 942. Each nucleotide 942 is made up of one or four nucleobases, specifically, one of adenine (A), cytosine (C), guanine (G) and thymine (T). At multiple locations along its length, the DNA strand 941 is wrapped one or more times around a histone 944, thereby often giving the DNA strand 941 what has been described as the appearance of being a “string” wrapped around a series of “beads” when viewed under a microscope. For a sequence of the nucleotides along part of the length of the DNA strand 941 to be expressed, that part of the length of the DNA strand 941 must be able to be temporarily straightened out and split to allow the nucleotides therealong to become sufficiently accessible for being copied. If that part of the length of the DNA strand 941 is unable to be straightened out and/or if the nucleotides therealong are not allowed to be made accessible, then such copying cannot occur, and that sequence of nucleotides is thereby prevented from exerting any influence on the activities within the cell.

It has been found that there multiple mechanisms by which the expression of portions of a genome are controlled by the corresponding epigenome. As depicted, in one such mechanism, a subset of the nucleotides 942 along the length of the DNA strand 941 may be “tagged” with a methyl group (M), which may have the effect of controlling the degree to which at least that particular nucleotide is able to be made accessible to be expressed. Alternatively or additionally, one or more tails 945 of each histone 944 may be “tagged” with an epigenetic factor (F), which may have the effect of changing how tightly a portion of the DNA strand 941 is wrapped around that histone 944, thereby affecting the degree to which that portion of the DNA strand 941 is able to be straightened out to be expressed.

The genome/epigenome printing device 700 may be capable of printing either or both of genetic or epigenetic material 940 for a new biological organism. With such material 940 so printed, any of a variety of techniques familiar to those skilled in the art may be employed to begin the generation of the new organism from that material 940. By way of example, the newly generated material 940 may be inserted into an existing living cell in a manner that supplants the genetic and/or epigenetic material already originally in place therein. The now modified cell may then be placed in the cultivation environment provided by the cultivation system 800.

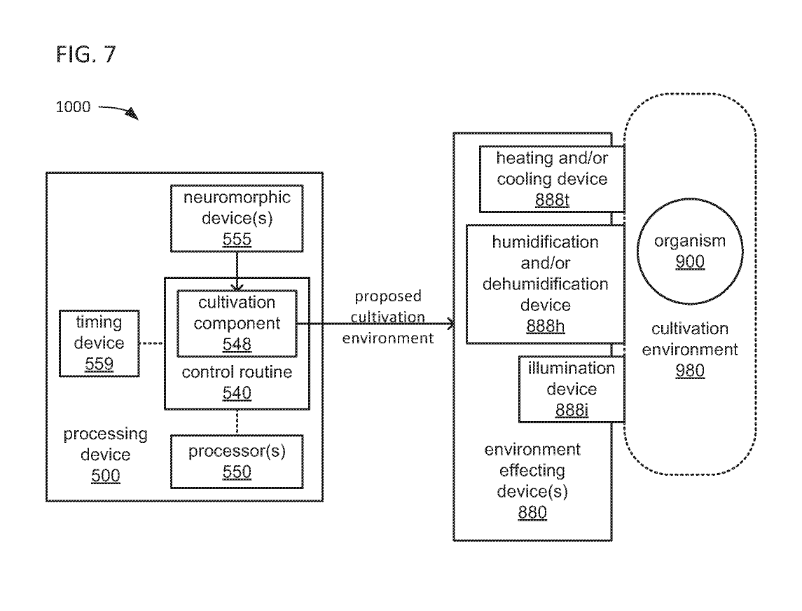

FIG. 7 depicts aspects of creating a particular cultivation environment 980 in which to cultivate a new biological organism 900. As depicted, the environment effecting devices 880 of the cultivation system 800 may include any of a variety of devices that are capable of exerting an effect on one or more conditions present within the cultivation environment 980. By way of example, the environment effecting devices 880 may include a heating and/or cooling device 888t to control the ambient temperature within the cultivation environment 980, including and not limited to, any of a variety of types of heater and/or any of a variety of types of chiller and/or refrigerator. Also by way of example, the environment effecting devices 880 may include a humidification and/or dehumidification device 888h to the humidity within the cultivation environment 980, including and not limited to, any of a variety of types of device employing ultrasound, steam generation, a wicking mechanism, etc. to add moisture, and/or any of a variety of types of device employing cooling, etc. to reduce moisture. Further by way of example, the environment effecting devices 880 may include an illumination device 888i to provide a controllable amount and/or type of lighting in the cultivation environment 980, including and not limited to one or more lighting components that are capable of providing light with an adjustable color spectrum, intensity, direction, etc., and/or the capability to adjust one or more of such lighting characteristics over time to mimic daily cycles, seasonal change, etc.

As will be familiar to those skilled in the art, such environmental conditions as those just discussed tend to change throughout each day (e.g., changes in intensity, color spectrum and/or direction of lighting), as well as varying over a longer multi-day timescales in a natural environment (e.g., weather changes and/or changes associated with changing seasons). Thus, the proposed cultivation environment conditions output by the neural network 570 may specify a daily cycle of changes for one or more environmental conditions, and/or changes that are to be effected in the cultivation environment 980 over a longer period of time to mimic changing seasonal conditions and/or to coincide with one or more particular phases of the growth of the new biological organism. The processor(s) 550 may be caused by further execution of the cultivation component 548 to use the timing device 559 to monitor the passage of time and determine when to apply each such change specified by the proposed cultivation environment conditions.

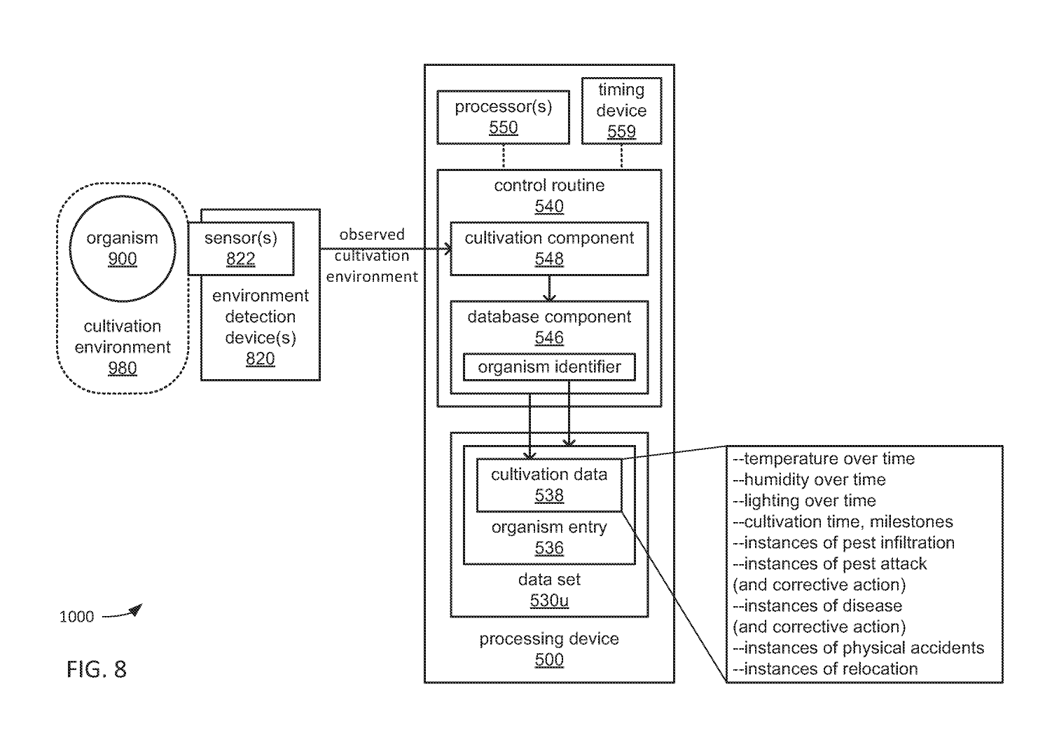

FIG. 8 depicts aspects of monitoring the cultivation environment 980 in which the new biological organism 900 is cultivated. As depicted, the environment effecting devices 820 of the cultivation system 800 may include any of a variety of sensors 822 that are capable of monitoring one or more conditions present within the cultivation environment 980. The conditions so monitored may largely mirror the conditions that may be actively maintained by the earlier discussed environment effecting devices 880, including and not limited to temperature, humidity, lighting, etc. Alternatively or additionally, the conditions so monitored may include still other conditions, including and not limited to, cultivation time, instances of pest infiltration and/or attack (and/or corrective action taken), instances of disease (and/or corrective action taken), instances of physical impacts and/or other physical events/accidents, instances of relocation within the cultivation environment 980, instances of exposure to pesticides and/or herbicides, etc.

As will be familiar to those skilled in the art, although the environment effecting devices 880 may be operated to enact the proposed cultivation environment conditions within the cultivation environment 980, the actual conditions created therein may be caused to vary based on any of a variety of factors. Such factors may include, and not limited to, activities carried out by personnel within and/or near the cultivation environment 980 (e.g., instances of the new biological organism 900 being moved about within the cultivation environment 980, either intentionally or by accident), environmental conditions external to the cultivation environment 980 that may infiltrate the cultivation environment 980 to some degree (e.g., instances of infiltration of insects that may attack the new biological organism 980, perhaps causing the onset of a disease), events such as a brief loss of power and/or water relied upon for the cultivation environment, etc. Therefore, it may be deemed desirable to monitor the actual conditions within the cultivation environment 980, rather than to assume that those conditions are in compliance with what is specified in the proposed cultivation environment conditions output by the neural network 570.

As also depicted, as observations are made of the actual conditions within the cultivation environment 980, the processor(s) 550 may be caused by further execution of the database component 546 to store those observed cultivation environment conditions as part of the cultivation data 538 within the organism entry earlier generated for the new biological organism 900. In so doing, the processor(s) may also be caused to employ indications of the current time provided by the timing device 559 in time-stamping such stored observations to enable the manner in which the actual conditions within the cultivation environment changed over time to be review and/or analyzed.

The processor(s) 550 may be further caused by further execution of the cultivation component 548 to monitor for instances in which one or more aspects of the actual conditions within the cultivation environment 980 diverge from the proposed cultivation environment conditions provided by the neural network 570 to a degree that exceeds a predetermined threshold. In response to such instances, the processor(s) 550 may be caused to add an indication of such a divergence, the degree of divergence and/or when it occurred to the cultivation data 538 within the organism entry 536 for the new biological organism 900. Alternatively or additionally, the processor(s) 550 may be caused to provide a notice of such instances on the display 580 to notify an operator of the organism development system 1000.

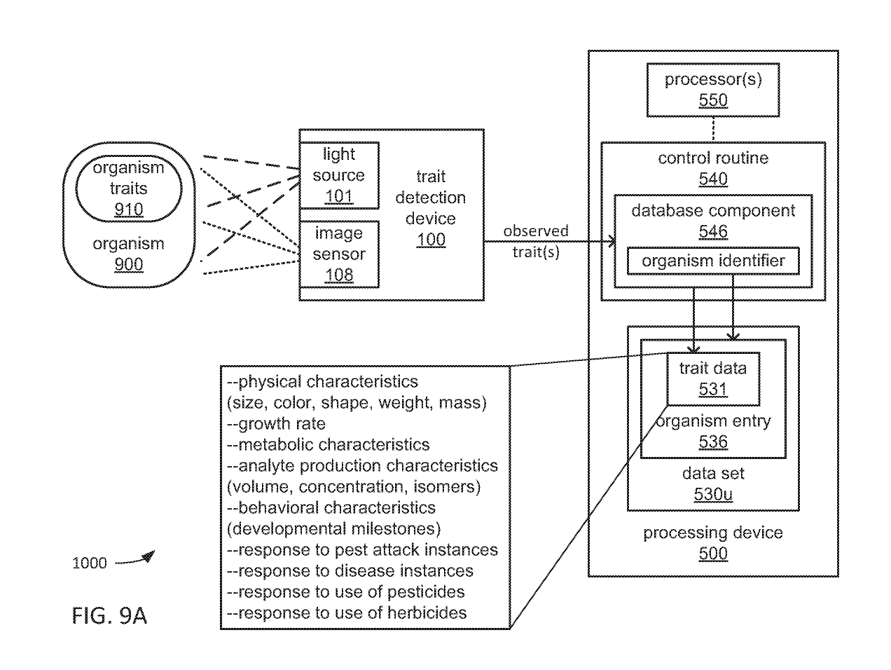

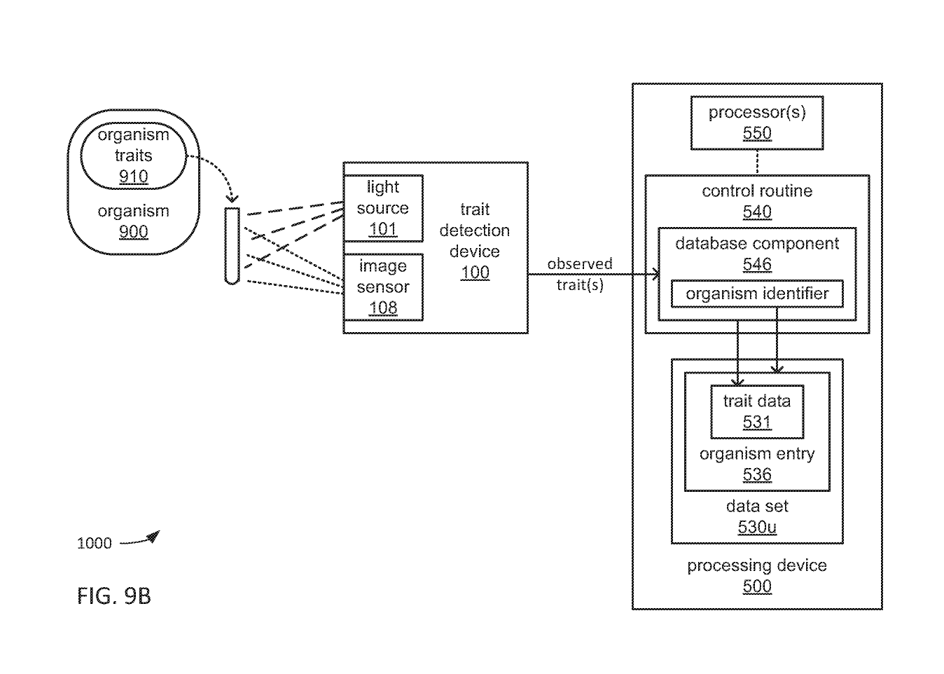

FIG. 9 depicts aspects of a pair of alternate approaches to detecting traits 910 of the new biological organism 900. In FIG. 9A, at least a portion of the new biological organism 900 is depicted as being directly scanned by an example implementation of the trait detection device 100. In FIG. 9B, a cutting, extract, preprocessed portion, emission or other derivative of the new biological organism 900 is depicted as being scanned by another example implementation of the trait detection device 100.

Which approach may be used may depend on various factors such as what the new biological organism 900 is, what traits are sought to be detected, whether light used to illuminate the new biological organism 900 or a derivative thereof is to pass therethrough or is to be reflected therefrom, etc. By way of example, where the trait that is sought to be detected is for the new biological organism to be of a particular color (e.g., a particular shade of blue), the approach depicted in FIG. 9A of directly scanning at least a portion of the new biological organism may be appropriate to determine the spectrum of visible light that is reflected from one or more surfaces of at least that portion. As will be familiar to those skilled in the art, the use of blue pigments in biological organisms is quite rare. Instead, in the vast majority of cases where a biological organism reflects visible blue light, it is because the surface from which the light is reflected incorporates microscopic surface texturing and/or other micro-scale geometry that manipulates light that shines onto the surface so that its visible blue light that is reflected most strongly.

However, by way of another example, where the trait that is sought to be detected is the emission of a particular analyte (e.g., the production of a particular oil or acidic substance), the approach depicted in FIG. 9B of scanning an cutting, extract, residue collected from a surface, ground up portion, or other form of derivative of the new biological organism 900 may be appropriate to enable detection of individual chemicals and/or chemical components. As will be familiar to those skilled in the art, the identification of particular micro-scale structures, such as molecular structures associated with particular chemical components, often requires the preparation of thin slices of a biological organism onto slides or the suspension of small cuttings and/or ground-up portions of a biological organism in liquid where light of controlled characteristics may be shown therethrough. Recent advances in the use of optical scanning technologies to detect specific chemical compounds has recently progressed to a degree that light of highly controlled characteristics may now be used to distinguish between even differing isomers of a chemical compound.

As depicted in each of FIGS. 9A and 9B, the trait detection device 100 incorporates a light source 101 that emits a light onto and/or through the new biological organism 900 and/or derivative thereof that is to be optically scanned, and an image sensor 108 that performs the scanning function using the emitted light. The light source 101 may emit any of a variety of types of light, including and not limited to, collimated light, laser light, monochromatic light, light made up of a controlled spectrum of frequencies, light made up of a controlled combination of selected individual frequencies, etc. The image sensor 108 may employ any of a variety of optical scanning and/or image capture technologies, including and not limited to, a two-dimensional pixel array of light-sensitive components, a linear array of light-sensitive components, combinations of optically-aligned light-sensitive components that are each configured to capture light within a different predetermined range of frequencies, etc. In some embodiments, the light source 101 and the image sensor 108 may be a single combined component that performs both functions in a tightly coordinated manner, as is the case with a variety of forms of scanning sensor employing pulsed and/or monochromatic laser light that projects one or more patterns onto surfaces for scanning.

Just as the selection among the two approaches depicted in FIGS. 9A and 9B may be at least partially dictated by the trait that is sought to be detected, the choice of light emission technology and/or scanning technology employed in detecting that trait may also be dictated by the trait that is sought to be detected. Returning to the above example of a particular shade of blue being sought for, the use of a combination of a light source 101 capable of emitting a wide spectrum of known characteristics and an image sensor 108 capable of detecting wide spectrum of light frequencies may be deemed appropriate. However, and returning to the above example of a particular analyte being sought for, the use of a combination of a light source 101 that emits collimated and/or laser light of a particular frequency or range of frequencies and an image sensor 108 optimized for and/or limited to detecting light of a particular frequency or range of frequencies may be deemed appropriate.

It should be noted, however, that despite these depictions and this detailed discussion of the use of light and/or optical scanning technologies in detecting observed traits of the new biological organism, other embodiments are possible in which the trait detection device 100 may use entirely different mechanisms and/or technologies to detect observed traits that may not be amenable to detection through the use of light and/or optical scanning. Indeed, among such traits as may be sought to be detected may be traits that are amenable to far simpler forms of detection. By way of example, where the trait sought to be detected is weight, the trait detection device 100 may incorporate a load cell or other weight-sensitive component to measure the weight of the new biological organism.

Regardless of the trait(s) sought to be detected and the technology employed to effect such detection by the trait detection device 100, the processor(s) 550 may be further caused to monitor the trait detection device 100 for observed traits, and to add indications of each observed trait to the trait data 531 within the organism entry 536 for the new biological organism 900. Alternatively or additionally, the processor(s) 550 may be caused to provide a notice of observed traits on the display 580 to notify an operator of the organism development system 1000.

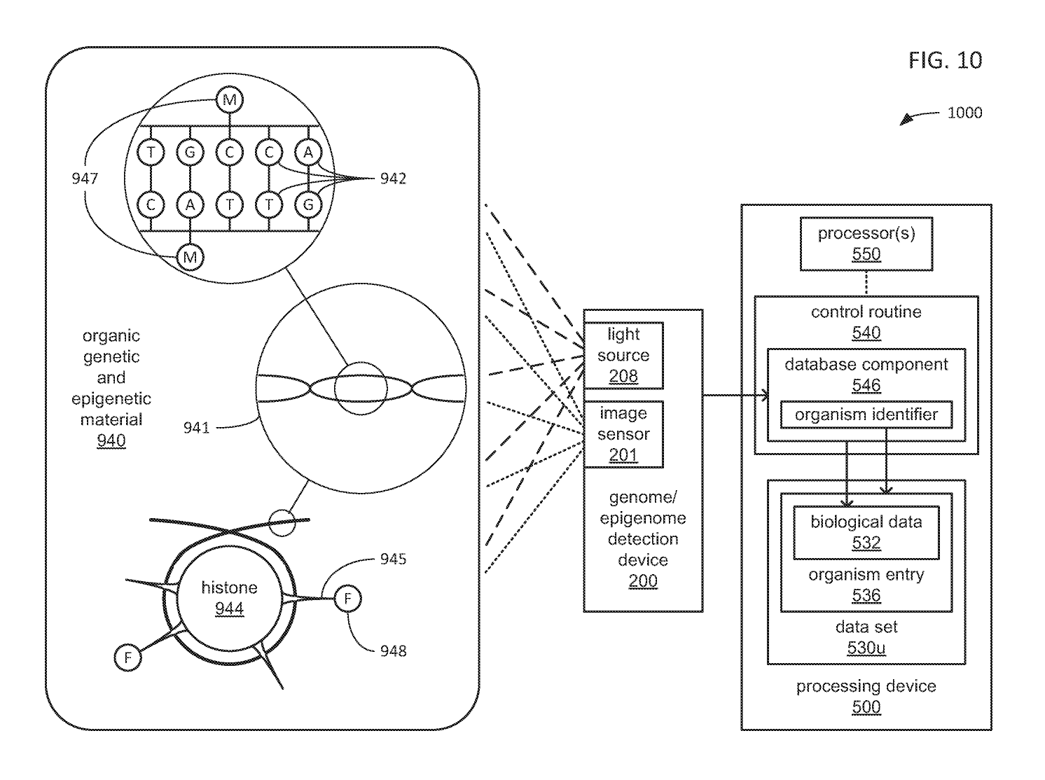

FIG. 10 depicts aspects of detecting the genome and/or epigenome of the new biological organism 900. As will be familiar to those skilled in the art, although the new biological organism 900 may have been cultivated from one or more cells that have been provided with artificially generated genome and/or epigenome (e.g., as a result of being “printed” by the genome/epigenome printing device 700), inaccuracies in the process of generating the artificial genome and/or epigenome can occur. Also, as those skilled in the art will readily recognize, the process of making copies of genes during replication as part of cell reproduction is known to be prone to some degree of error leading to the eventual production of mutations. As those skilled in the art will also readily recognize, some mutations can bring about significant changes in the traits of an organism.

It should be noted that where an error in printing and/or the occurrence of a mutation in cell replication results in the new biological organism 900 having one or more particular observed traits, even if the one or more traits are deemed to be undesirable, the recordation within the usage data set 530u of such a correlation between a particular genome and/or epigenome and the one or more particular traits is still potentially useful in further refining the training of the neural network 570. Thus, the genome/epigenome detection device 200 may be employed to confirm the genome and/or epigenome of the new biological organism 900, and where the genome and/or epigenome has diverged from what was intended, the genome/epigenome device 200 may be employed to detect the actual genome and/or epigenome of the new biological organism 900 for purposes of recordation.

The processor(s) 550 may be further caused to monitor the genome/epigenome detection device 200 for indications of the genome and/or epigenome that is detected thereby. Where the observed genome/epigenome is found to have diverged from the genome and/or epigenome that the new biological organism 900 was intended to have (i.e., diverged from the proposed genome and/or epigenome derived by the neural network 570 for the new biological organism 900) to at least a predetermined degree, the actual genome and/or epigenome that the new biological organism 900 is observed as having may be stored within the entry 536 for the new biological organism 900 as the biological data 532 in lieu of the genome and/or epigenome that the new biological organism 900 was intended to have. Still, it may be that some indication of the details of the divergence therebetween may also be stored as part of the biological data 532 for sake of future reference.

Alternatively or additionally, the processor(s) 550 may be caused to provide a notice of such a divergence in genome and/or epigenome on the display 580 to notify an operator of the organism development system 1000 of the discovery of that divergence. Such an indication provided to the operator may be deemed useful in informing the operator of the possible need to try again to generate and cultivate the new biological organism 900.

Turning to FIGS. 5C and 5D, with the new biological organism 900 having been generated and cultivated, and with the various observations concerning traits, cultivation environment, genome and/or epigenome having been captured and recorded within the organism entry 536 generated for the new biological organism 900, the neural network 570 may be further trained to be improve its functionality by incorporating the new information within that organism entry 536. Again, such further training of the neural network 570 may still be useful in improving its function regardless of whether the attempt made to produce a biological organism that has one or more sought-for traits was successful, or not.

Turning to FIG. 5C, the processor(s) 550 are caused to instantiate the neural network 570 within the one or more neuromorphic devices 520 based on the trained neuromorphic configuration data 535t, if the neural network 570 is not already so instantiated. The trait data 531 of the organism entry 536 for the new biological organism 900 is then provided to the inputs 572i of the neural network 570, and the corresponding biological data 532 and cultivation data 538 are presented to the output 572o thereof to further train the neural network 570. Turning to FIG. 5D, with the neural network 570 now further trained, the resulting further trained version of the trained neuromorphic configuration data 535t is retrieved from the one or more neuromorphic devices 520 and stored to be available for future use.

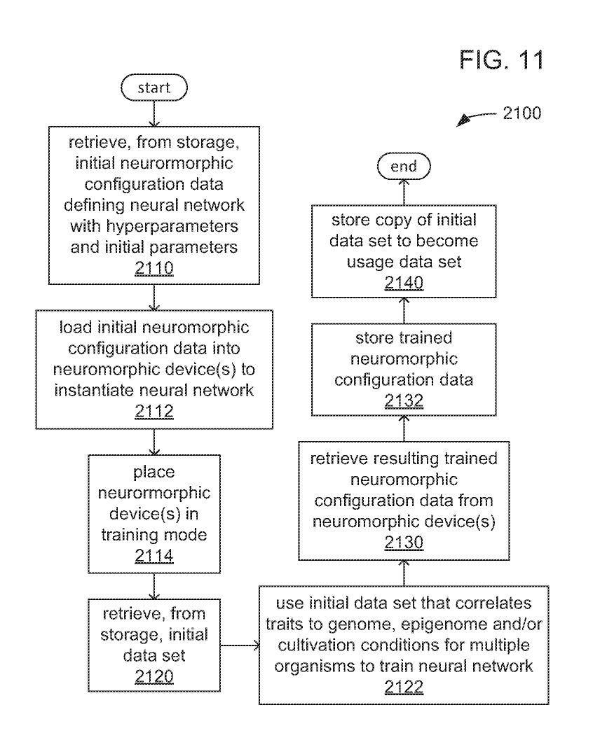

FIG. 11 is a flowchart 2100 depicting aspects of the operation of the organism development system 1000. More specifically, FIG. 11 depicts aspects of operations performed by the processor(s) 550 of the processing device 500 under the control of instructions of the control routine 540 in training the neural network 570.

At 2110, a processor of an organism development system (e.g., the one or more processors 550 of the organism development system 1000) retrieves from storage initial neuromorphic configuration data (e.g., the initial neuromorphic configuration data 535i from the storage 560). As has been discussed, such initial neuromorphic configuration data may include hyperparameters that define structural features of a neural network, along with initial parameters associated with the triggering of the artificial neurons of the neural network (e.g., the artificial neurons 577 of the neural network 570) that place the neural network in a known initial state in preparation for training.

At 2112, the processor may load the initial neuromorphic configuration data into the one or more neuromorphic devices (e.g., via the storage interface 529 within one or more of the neuromorphic devices 520) to instantiate the neural network therein in preparation for the training of the neural network. At 2114, the processor may place the one or more neuromorphic devices in a training mode to enable training with training data provided to both inputs and outputs of the one or more neuromorphic devices (e.g., the inputs 572i and outputs 572o).

At 2120, the processor may retrieve, from the storage, an initial data set to be used for training the neural network (e.g., the initial data set 530i). At 2122, the processor may use the initial data set to perform the training of the neural network. As has been discussed, the initial data set may be made up of numerous organism entries (e.g., the organism entries 536), where each organism entry correlates traits of a biological organism to one or more of a genome, an epigenome and cultivation environment conditions of that biological organism. In so using the initial data set to train the neural network, for each organism, indications of traits may be presented to the inputs of the neural network, while indications of one or more of the genome, epigenome and cultivation environment conditions may be presented to the outputs.

At 2130, following such training, the processor may retrieve trained neuromorphic configuration data that defines the neural network, as now trained (e.g., the trained neuromorphic configuration data 535t), from the one or more neuromorphic devices. At 2132, the processor may then store the trained neuromorphic configuration data within the storage to enable its future retrieval at a later time when the neural network is to be used. In preparation for such future use, the processor may also store a copy of the initial data set within the storage as a usage data set (e.g., the usage data set 530u) they may be augmented with new organism entries over time, while leaving the initial data set unchanged for a possible future occasion where it may be needed to again perform an initial training of the neural network.

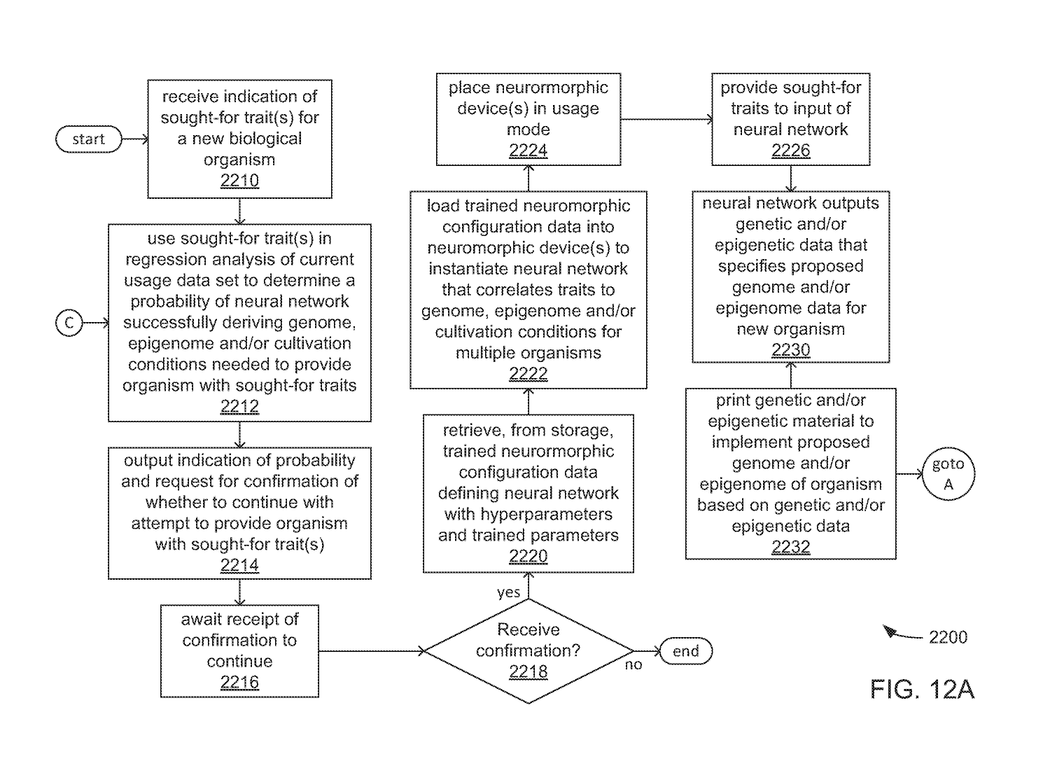

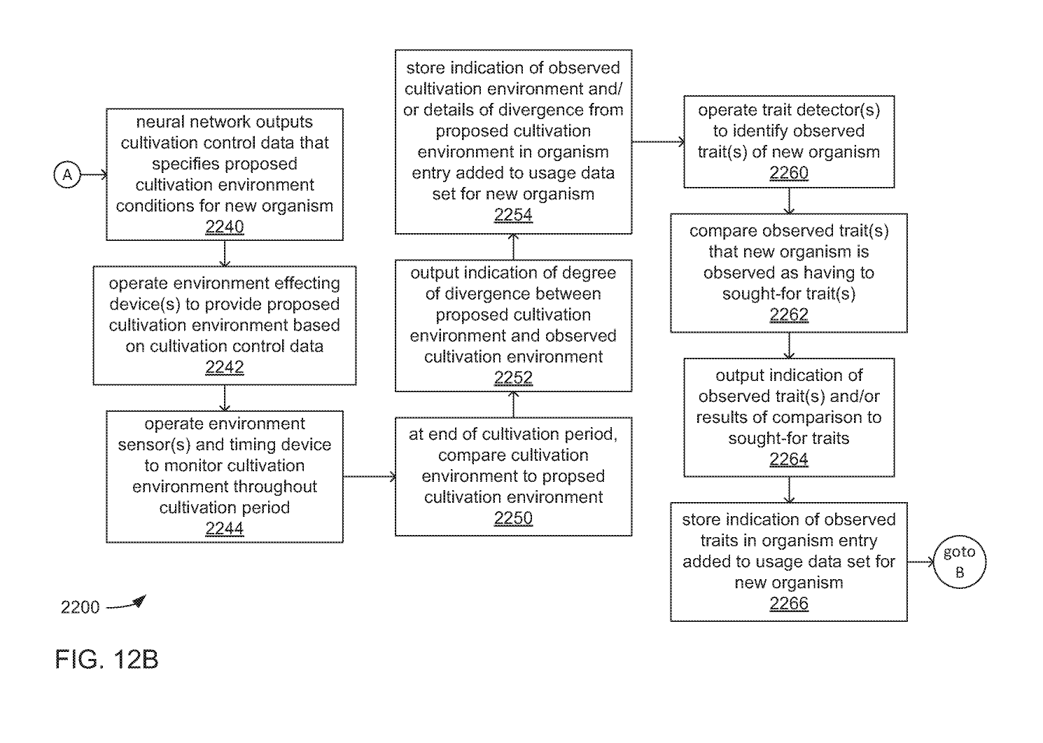

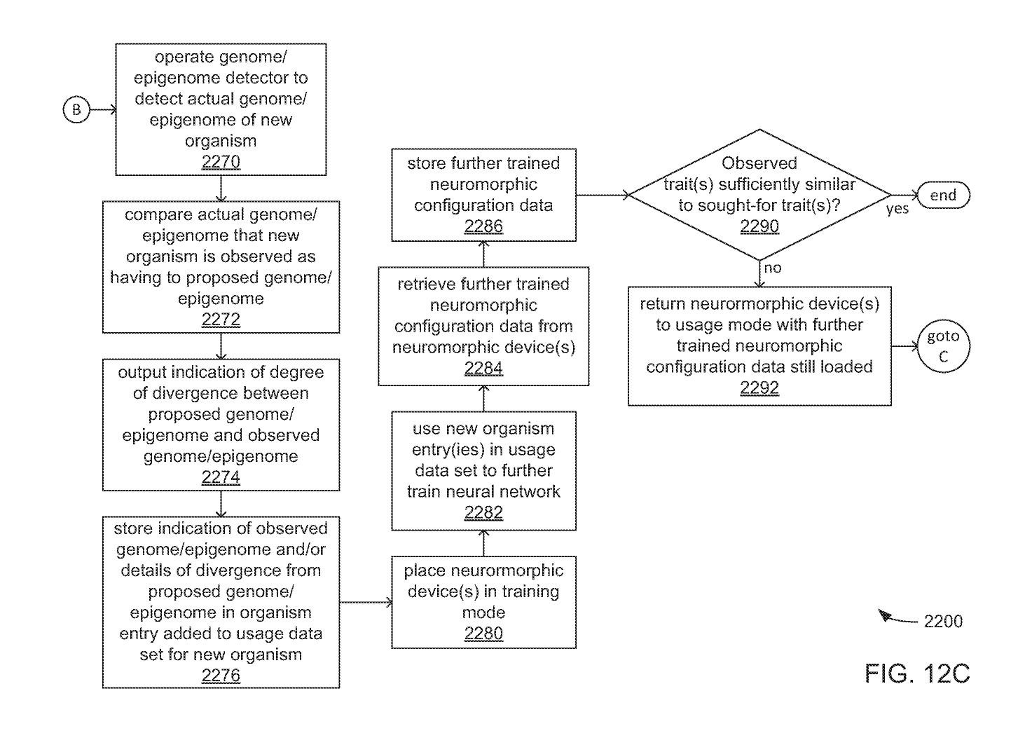

FIG. 12 is a flowchart 2200 depicting aspects of the operation of the organism development system 1000. More specifically, FIG. 12 depicts aspects of operations performed by the processor(s) 550 of the processing device 500 under the control of instructions of the control routine 540 in using the neural network 570 as part of developing a new biological organism 900.

At 2210, a processor of an organism development system (e.g., the one or more processors 550 of the organism development system 1000) receives an indication of one or more sought-for traits for a new biological organism. As has been discussed, such an indication of sought-for traits may be provided via an input device (e.g., the input device 510) that the processor may operate to provide an operator of the organism development system with a user interface (UI).

At 2212, the processor may use the sought-for traits in a regression analysis performed with a current usage data set (e.g., the usage data set 530u) to determine a probability that a neural network of the organism development system (e.g., the neural network 570) will successfully derive a proposed genome, a proposed epigenome and/or proposed cultivation environment conditions that will beget a new biological organism that has the sought-for traits. As has been discussed, the usage data set may be made up of numerous organism entries (e.g., the organism entries 536), where each organism entry correlates traits of a biological organism to one or more of a genome, an epigenome and cultivation environment conditions of that biological organism. As has also been discussed, the usage data set contains such information for all of the biological organisms that the neural network has been trained with, including any previously developed new biological organisms that have been developed using the organism development system that the neural network was further trained with after an initial training with an initial data set that served as the starting point for the usage data set.

At 2214, the processor may present an indication of the determined probability on a display (e.g., the display 580) to the operator, and may do so with a request for the operator to confirm that the attempt to generate and cultivate a new biological organism that has the sought-for traits should continue to be made. At 2216, the processor may await the receipt of such confirmation.

At 2218, if such confirmation is received, then at 2220, the processor may retrieve trained neuromorphic configuration data (e.g., the trained neuromorphic configuration data 535t) that defines the neural network as trained with all of the biological organisms for which information is stored within the usage data set. As has been discussed, such trained neuromorphic configuration data may include hyperparameters that define structural features of a neural network, along with trained parameters associated with the triggering of the artificial neurons of the neural network (e.g., the artificial neurons 577 of the neural network 570) in accordance with the complex function that the neural network has been trained to perform as a result of the training with the usage data set.

As has been discussed, with the neural network so trained, the neural network correlates traits to genomes, epigenomes and/or cultivation environment conditions for numerous biological organisms. At 2222, the processor may load the trained neuromorphic configuration data into one or more neuromorphic devices of the organism development system (e.g., the one or more neuromorphic devices 520) to instantiate the neural network therein. At 2224, the processor may place the one or more neuromorphic devices in a usage mode to enable the now instantiated neural network to be used. At 2226, the processor may provide indications of the earlier received sought-for traits to inputs of the neural network.

At 2230, the neural network may provide a proposed genome and/or a proposed epigenome at its outputs for use in generating a new biological organism that is meant to have the sought-for traits. At 2232, the processor may operate a genome/epigenome printing device (e.g., the genome/epigenome printing device 700) to generate the proposed genome and/or proposed epigenome as genetic and/or epigenetic material. As has been discussed, various techniques may be used to create a cell that incorporates or is otherwise based on the printed genetic and/or epigenetic material, including techniques for directly implanting the printed genetic and/or epigenetic material therein.

At 2240, the neural network may provide proposed cultivation environment conditions at its outputs for use in cultivating the new biological organism in a manner that is meant to aid in causing the new biological organism to have the sought-for traits. At 2242, the processor may operate one or more environment effecting devices (e.g., the one or more environment effecting devices 880) to provide a cultivation environment (e.g., the cultivation environment 980) with the proposed cultivation environment conditions. At 2244, the processor may operate one or more environment sensors to monitor the cultivation environment throughout the cultivation period.

At 2250, at the end of the cultivation period, the processor may compare the actual cultivation environment that was observed via the one or more environment sensors to the proposed cultivation environment output by the neural network. At 2252, the processor may present an indication to the operator (e.g., via the display) of the degree and/or details of a divergence between the observed cultivation environment and the proposed cultivation environment. At 2254, the processor may store an indication of at least the observed cultivation environment in an organism entry created within the usage data set for the new organism (e.g., the cultivation data 538 within a new organism entry 536 of the usage data set 530u). Where the observed cultivation environment diverged to at least a predetermined degree from the proposed cultivation environment, the processor may also store an indication of the details of such divergence and/or may store an indication of what the proposed cultivation environment was to enable future review of that divergence.

At 2260, the processor may operate one or more trait detection device(s) (e.g., the trait detection device 100) to identify the observed traits of the new organism. At 2262, the processor may compare the observed traits of the new organism to the sought-for traits that the new organism was intended to have. At 2264, the processor may present an indication to the operator (e.g., via the display) of the observed traits and/or the difference(s) between the observed traits and the sought-for traits. At 2266, the processor may store an indication of at least the observed traits in the organism entry created within the usage data set for the new organism (e.g., the trait data 531 within the new organism entry 536 of the usage data set 530u). Where the observed traits diverged to at least a predetermined degree from the sought-for traits, the processor may also store an indication of the details of such divergence and/or may store an indication of what the sought-for traits were to enable future review of that divergence.

At 2270, the processor may operate a genome/epigenome detection device (e.g., the genome/epigenome detection device 200) to identify the actual genome and/or epigenome that the new organism is observed to have. At 2272, the processor may compare the observed genome and/or epigenome of the new organism to the proposed genome and/or epigenome output by the neural network. At 2274, the processor may present an indication to the operator (e.g., via the display) of the degree and/or details of a divergence between the observed genome and/or epigenome and the proposed genome and/or epigenome. At 2276, the processor may store an indication of at least the observed genome and/or epigenome in the organism entry created within the usage data set for the new organism (e.g., the biological data 532 within the new organism entry 536 of the usage data set 530u). Where the observed genome and/or epigenome diverged to at least a predetermined degree from the proposed genome and/or epigenome, the processor may also store an indication of the details of such divergence and/or may store an indication of what the proposed genome and/or epigenome were to enable future review of that divergence.

At 2280, the processor may place the one or more neuromorphic devices in a training mode in preparation for further training of the neural network. At 2282, following such storage of cultivation environment conditions, traits, genome and/or epigenome within the new organism entry within the usage data set for the new organism, the processor may use at least the new entry so created for the new organism within the usage data to further train the neural network. At 2284, following such further training, the processor may retrieve the now further trained neuromorphic configuration data (e.g., the neuromorphic configuration data 535t, after such further training) from the one or more neuromorphic devices, and may store it at 2286 for future use.

At 2290, if the observed traits of the new organism are not similar to the sought-for traits to within a predetermined degree, then the processor may return the one or more neuromorphic devices to the usage state at 2292. In so doing, if the processor may load the further trained neuromorphic configuration data into the one or more neuromorphic devices, if it is not already so loaded. The processor may then return to using the sought-for traits in repeating the regression analysis at 2212.

The foregoing disclosure and description of the invention is illustrative and explanatory thereof. Various changes in the details of the illustrated construction can be made within the scope of the appended claims without departing from the true spirit of the invention.

There is thus disclosed a processing device employing neuromorphic processing to develop a biological organism, as well as an organism development system incorporating such a processing device. A processing device includes storage configured to store a usage data set and trained neuromorphic configuration data, wherein: the usage data set includes multiple organism entries that each correspond to one of multiple organisms; each organism entry includes trait data indicative of at least one trait of the corresponding organism, and biological data indicative of a genome or an epigenome of the corresponding organism; and the trained neuromorphic configuration data includes multiple trained parameters indicative of training of a neural network with at least a portion of the usage data set. The processing device also includes at least one neuromorphic device including multiple sets of hardware components, wherein: each set of hardware components is configured to store at least one trained parameter of the multiple trained parameters to implement an artificial neuron of multiple artificial neurons of the neural network; and the neural network is configured by at least the portion of the trained neuromorphic configuration data to derive a proposed genome or a proposed epigenome of a new organism based on a sought-for trait provided to inputs of the at least one neuromorphic device. The processing device further includes a processor coupled to the storage and to the at least one neuromorphic device, wherein the processor is configured to train the neural network with at least the portion of the usage data set and generate the trained neuromorphic configuration data, wherein for each organism entry of the usage data set, the processor performs operations including: provide the trait data to the inputs of the at least one neuromorphic device; and provide the biological data to outputs of the at least one neuromorphic device. The processor is also configured to use the neural network to develop the new organism, wherein the processor performs operations including: receive an indication of the sought-for trait that the new organism is meant to have from an input device coupled to the processor; provide the sought-for trait to the inputs of the at least one neuromorphic device; retrieve, from the outputs of the at least one neuromorphic device, the proposed genome or the proposed epigenome of the new organism derived by the neural network; and transmit the proposed genome or the proposed epigenome derived by the neural network to a printing device to enable generation of genetic or epigenetic material of the new organism.

Each organism entry of the usage data set may further include cultivation data indicative of a cultivation environment condition of the corresponding organism; during training of the neural network with at least the portion of the usage data set, the processor, for each organism entry of the usage data set, may additionally present the cultivation data to the outputs of the at least one neuromorphic device; and the neural network may be further configured by at least the portion of the trained neuromorphic configuration data to derive a proposed cultivation environment condition based on the sought-for trait provided to the inputs of the at least one neuromorphic device. During use of the neural network to develop the new organism, the processor may perform operations including: retrieve, from the outputs of the at least one neuromorphic device, the proposed cultivation environment condition derived by the neural network, and transmit the proposed cultivation environment condition derived by the neural network to a cultivation environment system to enable cultivation of the new organism in accordance with the proposed cultivation environment condition.

The processor may be further configured to: operate the cultivation environment system to monitor a cultivation environment condition of the new organism that is observed during cultivation of the new organism; following cultivation of the organism, compare the observed cultivation environment condition to the proposed cultivation environment condition; and in response to a divergence between the observed cultivation environment condition and the proposed cultivation environment condition that exceeds a predetermined threshold, store an indication of the observed cultivation environment condition as the cultivation data in a new organism entry generated in the usage data set for the new organism to enable further training of the neural network with the new organism entry in which the cultivation data of the new organism entry is provided to the outputs of the at least one neuromorphic device.

The processor may be further configured to, in response to the divergence between the observed cultivation environment condition and the proposed cultivation environment condition that does not exceed the predetermined threshold, store an indication of the proposed cultivation environment condition as the cultivation data in the new organism entry to enable further training of the neural network with the new organism entry in which the cultivation data of the new organism entry is provided to the outputs of the at least one neuromorphic device.

The processor may be further configured to: operate a trait detection device to detect an observed trait of the new organism or of a derivative of the new organism; store an indication of the observed trait as the trait data in a new organism entry generated in the usage data set for the new organism; and further train the neural network with the new organism entry, wherein the processor performs operations including provide the trait data of the new organism entry to the inputs of the at least one neuromorphic device, and provide the biological data of the new organism entry to the outputs of the at least one neuromorphic device.

The derivative of the new organism may be selected from a group consisting of: a slice of the new organism mounted on a slide or suspended in liquid; a ground-up portion of the new organism; a substance collected from a surface of the new organism; an extract of at least a portion of the new organism; a waste product excreted by the new organism; an isolated cell of the new organism; and genetic or epigenetic material of the new organism.

The processor may be further configured to: following generation and cultivation of the new organism, operate a genome/epigenome detection device to identify a genome or epigenome that the new organism is observed to have; compare the observed genome to the proposed genome, or the observed epigenome to the proposed epigenome; and in response to a divergence between the observed genome and the proposed genome, or between the observed epigenome and the proposed epigenome, that exceeds a predetermined threshold, store an indication of the observed genome or epigenome as the biological data in a new organism entry generated in the usage data set for the new organism to enable further training of the neural network with the new organism entry.

The processor may be further configured to, in response to the divergence between the observed genome and the proposed genome, or between the observed epigenome and the proposed epigenome, that does not exceed the predetermined threshold, store an indication of the proposed genome or epigenome as the biological data in the new organism entry to enable further training of the neural network with the new organism entry.

The processor may be further configured to perform operations including: perform a regression analysis with the sought-for trait and the usage data to determine a probability of success in generating the new organism to have the sought-for trait; output an indication of the probability on a display coupled to the processor, along with a request for confirmation to proceed with generating the new organism; and delay at least the transmission of the proposed genome or the proposed epigenome to the printing device until confirmation to proceed with generating the new organism is received from the input device.

The trained neuromorphic configuration data may include at least one hyperparameter indicative of a structure of the neural network, wherein the hyperparameter may be selected from a group consisting of: a quantity of the multiple artificial neurons of the neural network; a quantity of layers of the neural network into which the multiple artificial neurons are organized; an indication of connections among the multiple artificial neurons within the neural network; and an indication of a direction of flow of information through at least a subset of connections among the multiple artificial neurons within the neural network.

An organism development system includes at least one neuromorphic device including multiple sets of hardware components, wherein: each set of hardware components is configured to store at least one trained parameter of trained neuromorphic configuration data to implement an artificial neuron of a neural network; the neural network is configured by the trained neuromorphic configuration data to derive and provide at outputs of the at least one neuromorphic device a proposed genome or a proposed epigenome of a new organism that is meant to have a sought-for trait provided to inputs of the at least one neuromorphic device; the trained neuromorphic configuration data is generated by the neural network during training of the neural network with at least a portion of a usage data set, wherein the usage data set includes multiple organism entries, and each organism entry includes trait data indicative of at least one trait of a corresponding organism, and biological data indicative of a genome or an epigenome of the corresponding organism. The organism development system also includes: a genome/epigenome printing device configured to print genetic or epigenetic material of the new organism to enable generation of the new organism based on the proposed genome or epigenome, respectively; and a trait detection device configured to detect an observed trait of the new organism following at least the generation of the new organism.

The organism development system may further include a processor configured to train the neural network with at least the portion of the usage data set, wherein, for each organism entry of the usage data set, the processor performs operations including: provide the trait data to the inputs of the at least one neuromorphic device; and provide the biological data to the outputs of the at least one neuromorphic device. The processor may also be configured to use the neural network to develop the new organism, wherein the processor performs operations including: receive an indication of the sought-for trait from an input device coupled to the processor; provide the sought-for trait to the inputs of the at least one neuromorphic device; retrieve, from the outputs of the at least one neuromorphic device, the proposed genome or the proposed epigenome; and provide the proposed genome or the proposed epigenome to the printing device. The processor may be further configured to: operate the trait detection device to detect the observed trait of the new organism or of a derivative of the new organism; generate a new organism entry in the usage data set for the new organism; store an indication of the observed trait as the trait data in the new organism entry; and further train the neural network with the new organism entry.

Each organism entry of the usage data set may further include cultivation data indicative of a cultivation environment condition of the corresponding organism; the neural network may be further configured by at least the portion of the trained neuromorphic configuration data to derive and provide at the outputs of the at least one neuromorphic device a proposed cultivation environment condition based on the sought-for trait provided to the inputs of the at least one neuromorphic device; and the organism development system may further include a cultivation environment system configured to cultivate the new organism in accordance with the proposed cultivation environment condition.

The organism development system may further include a processor configured to: generate a new organism entry in the usage data set; operate the cultivation environment system to monitor a cultivation environment condition of the new organism that is observed during cultivation of the new organism; following cultivation of the organism, compare the observed cultivation environment condition to the proposed cultivation environment condition; and in response to a divergence between the observed cultivation environment condition and the proposed cultivation environment condition that exceeds a predetermined threshold, store an indication of the observed cultivation environment condition as the cultivation data in the new organism entry to enable further training of the neural network with the new organism entry.

The processor may be further configured to, in response to the divergence between the observed cultivation environment condition and the proposed cultivation environment condition that does not exceed the predetermined threshold, store an indication of the proposed cultivation environment condition as the cultivation data in the new organism entry to enable further training of the neural network with the new organism entry.

The organism development system may further include a processor configured to: generate a new organism entry in the usage data set; following generation and cultivation of the new organism, operate a genome/epigenome detection device to identify a genome or epigenome that the new organism is observed to have; compare the observed genome to the proposed genome, or the observed epigenome to the proposed epigenome; and in response to a divergence between the observed genome and the proposed genome, or between the observed epigenome and the proposed epigenome, that exceeds a predetermined threshold, store an indication of the observed genome or epigenome as the biological data in the new organism entry to enable further training of the neural network with the new organism entry.

The processor may be further configured to, in response to the divergence between the observed genome and the proposed genome, or between the observed epigenome and the proposed epigenome, that does not exceed the predetermined threshold, store an indication of the proposed genome or epigenome as the biological data in the new organism entry to enable further training of the neural network with the new organism entry.

The organism development system may further include a processor configured to: perform a regression analysis with the sought-for trait and the usage data to determine a probability of success in generating the new organism to have the sought-for trait; output an indication of the probability on a display coupled to the processor, along with a request for confirmation to proceed with generating the new organism; and delay at least the printing of the genetic or epigenetic material until confirmation to proceed with generating the new organism is received from an input device coupled to the processor.

The sought-for trait may be selected from a group consisting of: a shape of the new organism; a size of the new organism; a weight of the new organism; a mass of the new organism; a color of the new organism; a growth rate of the new organism; a metabolic characteristic of the new organism; an analyte to be produced by the new organism; a volume of production of an analyte to be produced by the new organism; a chemical concentration of an analyte to be produced by the new organism; an isomer of the analyte to be produced by the new organism; a resistance of the new organism to a disease; a resistance of the new organism to attack by a pest; a resistance of the new organism to use of a pesticide; and a resistance of the new organism to use of a herbicide.

A computer-implemented method includes: receiving, at a processor, an indication of a sought-for trait of a new organism from an input device, and providing the sought-for trait to inputs of at least one neuromorphic device coupled to the processor, wherein: the at least one neuromorphic device comprises multiple sets of hardware components; each set of hardware components is configured to store at least one trained parameter of multiple trained parameters of trained neuromorphic configuration data to implement an artificial neuron of multiple artificial neurons of a neural network; and the neural network is configured by at least a portion of the trained neuromorphic configuration data to derive and provide at outputs of the at least one neuromorphic device a proposed genome or a proposed epigenome of the new organism based on the sought-for trait provided to inputs. The method also includes: retrieving, from the outputs of the at least one neuromorphic device, the proposed genome or the proposed epigenome of the new organism derived by the neural network, transmitting the proposed genome or the proposed epigenome derived by the neural network to a printing device to enable generation of genetic or epigenetic material of the new organism, and generating a new organism entry in a usage data set, wherein: the usage data set comprises multiple organism entries, and each organism entry comprises trait data indicative of at least one trait of a corresponding organism, and biological data indicative of a genome or an epigenome of the corresponding organism. The method further includes: following generation and cultivation of the new organism, operating a trait detection device to detect an observed trait of the new organism or of a derivative of the new organism; storing an indication of the observed trait as the trait data within the new organism within the new organism entry; and using at least the new entry to further train the neural network.

The computer-implemented method may further include training the neural network with at least the portion of the usage data set, wherein the training includes, for each organism entry of the usage data set, performing operations including: providing the trait data to the inputs of the at least one neuromorphic device; and providing the biological data to the outputs of the at least one neuromorphic device.

Each organism entry of the usage data set may further include cultivation data indicative of a cultivation environment condition of the corresponding organism; and the neural network may be further configured by at least the portion of the trained neuromorphic configuration data to derive and provide at the outputs of the at least one neuromorphic device a proposed cultivation environment condition based on the sought-for trait provided to the inputs of the at least one neuromorphic device. The method may further include: operating a cultivation environment system to cultivate the new organism in accordance with the proposed cultivation environment condition, and to monitor a cultivation environment condition of the new organism that is observed during cultivation of the new organism; following cultivation of the organism, comparing the observed cultivation environment condition to the proposed cultivation environment condition; and in response to a divergence between the observed cultivation environment condition and the proposed cultivation environment condition that exceeds a predetermined threshold, storing an indication of the observed cultivation environment condition as the cultivation data in the new organism entry to enable further training of the neural network with the new organism entry.

The computer-implemented method may further include, in response to the divergence between the observed cultivation environment condition and the proposed cultivation environment condition that does not exceed the predetermined threshold, storing an indication of the proposed cultivation environment condition as the cultivation data in the new organism entry to enable further training of the neural network with the new organism entry.

The computer-implemented method may further include: following generation and cultivation of the new organism, operating a genome/epigenome detection device to identify a genome or epigenome that the new organism is observed to have; comparing the observed genome to the proposed genome, or the observed epigenome to the proposed epigenome; and in response to a divergence between the observed genome and the proposed genome, or between the observed epigenome and the proposed epigenome, that exceeds a predetermined threshold, storing an indication of the observed genome or epigenome as the biological data in the new organism entry to enable further training of the neural network with the new organism entry.

The computer-implemented method may further include, in response to the divergence between the observed genome and the proposed genome, or between the observed epigenome and the proposed epigenome, that does not exceed the predetermined threshold, storing an indication of the proposed genome or epigenome as the biological data in the new organism entry to enable further training of the neural network with the new organism entry.

The computer-implemented method may further include: performing, by the processor, a regression analysis with the sought-for trait and the usage data to determine a probability of success in generating the new organism to have the sought-for trait; outputting an indication of the probability on a display coupled to the processor, along with a request for confirmation to proceed with generating the new organism; and delaying, by the processor, at least the transmission of the proposed genome or the proposed epigenome to the printing device until confirmation to proceed with generating the new organism is received from the input device.

Various other components may be included and called upon for providing for aspects of the teachings herein. For example, additional materials, combinations of materials, and/or omission of materials may be used to provide for added embodiments that are within the scope of the teachings herein.

Standards for performance, selection of materials, functionality, and other discretionary aspects are to be determined by a user, designer, manufacturer, or other similarly interested party. Any standards expressed herein are merely illustrative and are not limiting of the teachings herein.

When introducing elements of the present invention or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

While the invention has been described with reference to illustrative embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A processing device comprising:
storage configured to store a usage data set and trained neuromorphic configuration data, wherein:
the usage data set comprises multiple organism entries that each correspond to one of multiple organisms;
each organism entry comprises:
trait data indicative of at least one trait of the corresponding organism; and
biological data indicative of a genome or an epigenome of the corresponding organism; and
the trained neuromorphic configuration data comprises multiple trained parameters indicative of training of a neural network with at least a portion of the usage data set;
at least one neuromorphic device comprising multiple sets of hardware components, wherein:
each set of hardware components is configured to store at least one trained parameter of the multiple trained parameters to implement an artificial neuron of multiple artificial neurons of the neural network; and
the neural network is configured by at least the portion of the trained neuromorphic configuration data to derive a proposed genome or a proposed epigenome of a new organism based on a sought-for trait provided to inputs of the at least one neuromorphic device; and
a processor coupled to the storage and to the at least one neuromorphic device, wherein the processor is configured to:
train the neural network with at least the portion of the usage data set and generate the trained neuromorphic configuration data, wherein for each organism entry of the usage data set, the processor performs operations comprising:
provide the trait data to the inputs of the at least one neuromorphic device; and
provide the biological data to outputs of the at least one neuromorphic device; and
use the neural network to develop the new organism, wherein the processor performs operations comprising:
receive an indication of the sought-for trait that the new organism is meant to have from an input device coupled to the processor;
provide the sought-for trait to the inputs of the at least one neuromorphic device;
retrieve, from the outputs of the at least one neuromorphic device, the proposed genome or the proposed epigenome of the new organism derived by the neural network; and
transmit the proposed genome or the proposed epigenome derived by the neural network to a printing device to enable generation of genetic or epigenetic material of the new organism.

2. The processing device of claim 1, wherein:
each organism entry of the usage data set further comprises cultivation data indicative of a cultivation environment condition of the corresponding organism;
during training of the neural network with at least the portion of the usage data set, the processor, for each organism entry of the usage data set, additionally presents the cultivation data to the outputs of the at least one neuromorphic device;
the neural network is further configured by at least the portion of the trained neuromorphic configuration data to derive a proposed cultivation environment condition based on the sought-for trait provided to the inputs of the at least one neuromorphic device; and
during use of the neural network to develop the new organism, the processor performs operations comprising:
retrieve, from the outputs of the at least one neuromorphic device, the proposed cultivation environment condition derived by the neural network; and
transmit the proposed cultivation environment condition derived by the neural network to a cultivation environment system to enable cultivation of the new organism in accordance with the proposed cultivation environment condition.

3. The processing device of claim 2, wherein the processor is further configured to:
operate the cultivation environment system to monitor a cultivation environment condition of the new organism that is observed during cultivation of the new organism;
following cultivation of the organism, compare the observed cultivation environment condition to the proposed cultivation environment condition; and
in response to a divergence between the observed cultivation environment condition and the proposed cultivation environment condition that exceeds a predetermined threshold, store an indication of the observed cultivation environment condition as the cultivation data in a new organism entry generated in the usage data set for the new organism to enable further training of the neural network with the new organism entry in which the cultivation data of the new organism entry is provided to the outputs of the at least one neuromorphic device.

4. The processing device of claim 3, wherein the processor is further configured to, in response to the divergence between the observed cultivation environment condition and the proposed cultivation environment condition that does not exceed the predetermined threshold, store an indication of the proposed cultivation environment condition as the cultivation data in the new organism entry to enable further training of the neural network with the new organism entry in which the cultivation data of the new organism entry is provided to the outputs of the at least one neuromorphic device.

5. The processing device of claim 1, wherein the processor is further configured to:
operate a trait detection device to detect an observed trait of the new organism or of a derivative of the new organism;
store an indication of the observed trait as the trait data in a new organism entry generated in the usage data set for the new organism; and
further train the neural network with the new organism entry, wherein the processor performs operations comprising:
provide the trait data of the new organism entry to the inputs of the at least one neuromorphic device; and
provide the biological data of the new organism entry to the outputs of the at least one neuromorphic device.

6. The processing device of claim 5, wherein the derivative of the new organism is selected from a group consisting of:
a slice of the new organism mounted on a slide or suspended in liquid;
a ground-up portion of the new organism;
a substance collected from a surface of the new organism;
an extract of at least a portion of the new organism;
a waste product excreted by the new organism;
an isolated cell of the new organism; and
genetic or epigenetic material of the new organism.

7. The processing device of claim 1, wherein the processor is further configured to:
following generation and cultivation of the new organism, operate a genome/epigenome detection device to identify a genome or epigenome that the new organism is observed to have;
compare the observed genome to the proposed genome, or the observed epigenome to the proposed epigenome; and
in response to a divergence between the observed genome and the proposed genome, or between the observed epigenome and the proposed epigenome, that exceeds a predetermined threshold, store an indication of the observed genome or epigenome as the biological data in a new organism entry generated in the usage data set for the new organism to enable further training of the neural network with the new organism entry.

8. The processing device of claim 7, wherein the processor is further configured to, in response to the divergence between the observed genome and the proposed genome, or between the observed epigenome and the proposed epigenome, that does not exceed the predetermined threshold, store an indication of the proposed genome or epigenome as the biological data in the new organism entry to enable further training of the neural network with the new organism entry.

9. The processing device of claim 1, wherein the processor is further configured to perform operations comprising:
perform a regression analysis with the sought-for trait and the usage data to determine a probability of success in generating the new organism to have the sought-for trait;
output an indication of the probability on a display coupled to the processor, along with a request for confirmation to proceed with generating the new organism; and
delay at least the transmission of the proposed genome or the proposed epigenome to the printing device until confirmation to proceed with generating the new organism is received from the input device.

10. The processing device of claim 1, wherein the trained neuromorphic configuration data comprises at least one hyperparameter indicative of a structure of the neural network, wherein the hyperparameter is selected from a group consisting of:
a quantity of the multiple artificial neurons of the neural network;
a quantity of layers of the neural network into which the multiple artificial neurons are organized;
an indication of connections among the multiple artificial neurons within the neural network; and
an indication of a direction of flow of information through at least a subset of connections among the multiple artificial neurons within the neural network.

11. An organism development system comprising:
at least one neuromorphic device comprising multiple sets of hardware components, wherein:
each set of hardware components is configured to store at least one trained parameter of trained neuromorphic configuration data to implement an artificial neuron of a neural network;
the neural network is configured by the trained neuromorphic configuration data to derive and provide at outputs of the at least one neuromorphic device a proposed genome or a proposed epigenome of a new organism that is meant to have a sought-for trait provided to inputs of the at least one neuromorphic device;
the trained neuromorphic configuration data is generated by the neural network during training of the neural network with at least a portion of a usage data set, wherein:
the usage data set comprises multiple organism entries; and
each organism entry comprises trait data indicative of at least one trait of a corresponding organism, and biological data indicative of a genome or an epigenome of the corresponding organism;
a genome/epigenome printing device configured to print genetic or epigenetic material of the new organism to enable generation of the new organism based on the proposed genome or epigenome, respectively; and
a trait detection device configured to detect an observed trait of the new organism following at least the generation of the new organism.

12. The organism development system of claim 11, further comprising a processor configured to:
train the neural network with at least the portion of the usage data set, wherein, for each organism entry of the usage data set, the processor performs operations comprising:
provide the trait data to the inputs of the at least one neuromorphic device; and
provide the biological data to the outputs of the at least one neuromorphic device;
use the neural network to develop the new organism, wherein the processor performs operations comprising:
receive an indication of the sought-for trait from an input device coupled to the processor;
provide the sought-for trait to the inputs of the at least one neuromorphic device;
retrieve, from the outputs of the at least one neuromorphic device, the proposed genome or the proposed epigenome; and
provide the proposed genome or the proposed epigenome to the printing device;
operate the trait detection device to detect the observed trait of the new organism or of a derivative of the new organism;
generate a new organism entry in the usage data set for the new organism;
store an indication of the observed trait as the trait data in the new organism entry; and
further train the neural network with the new organism entry.

13. The organism development system of claim 11, wherein:
each organism entry of the usage data set further comprises cultivation data indicative of a cultivation environment condition of the corresponding organism;
the neural network is further configured by at least the portion of the trained neuromorphic configuration data to derive and provide at the outputs of the at least one neuromorphic device a proposed cultivation environment condition based on the sought-for trait provided to the inputs of the at least one neuromorphic device; and
the organism development system comprises a cultivation environment system configured to cultivate the new organism in accordance with the proposed cultivation environment condition.

14. The organism development system of claim 13, further comprising a processor configured to:
generate a new organism entry in the usage data set;
operate the cultivation environment system to monitor a cultivation environment condition of the new organism that is observed during cultivation of the new organism;
following cultivation of the organism, compare the observed cultivation environment condition to the proposed cultivation environment condition; and
in response to a divergence between the observed cultivation environment condition and the proposed cultivation environment condition that exceeds a predetermined threshold, store an indication of the observed cultivation environment condition as the cultivation data in the new organism entry to enable further training of the neural network with the new organism entry.

15. The organism development system of claim 14, wherein the processor is further configured to, in response to the divergence between the observed cultivation environment condition and the proposed cultivation environment condition that does not exceed the predetermined threshold, store an indication of the proposed cultivation environment condition as the cultivation data in the new organism entry to enable further training of the neural network with the new organism entry.

16. The organism development system of claim 11, further comprising a processor configured to:
generate a new organism entry in the usage data set;
following generation and cultivation of the new organism, operate a genome/epigenome detection device to identify a genome or epigenome that the new organism is observed to have;
compare the observed genome to the proposed genome, or the observed epigenome to the proposed epigenome; and
in response to a divergence between the observed genome and the proposed genome, or between the observed epigenome and the proposed epigenome, that exceeds a predetermined threshold, store an indication of the observed genome or epigenome as the biological data in the new organism entry to enable further training of the neural network with the new organism entry.

17. The organism development system of claim 16, wherein the processor is further configured to, in response to the divergence between the observed genome and the proposed genome, or between the observed epigenome and the proposed epigenome, that does not exceed the predetermined threshold, store an indication of the proposed genome or epigenome as the biological data in the new organism entry to enable further training of the neural network with the new organism entry.

18. The organism development system of claim 11, further comprising a processor configured to:
perform a regression analysis with the sought-for trait and the usage data to determine a probability of success in generating the new organism to have the sought-for trait;
output an indication of the probability on a display coupled to the processor, along with a request for confirmation to proceed with generating the new organism; and
delay at least the printing of the genetic or epigenetic material until confirmation to proceed with generating the new organism is received from an input device coupled to the processor.

19. The organism development system of claim 11, wherein the sought-for trait is selected from a group consisting of:
a shape of the new organism;
a size of the new organism;
a weight of the new organism;
a mass of the new organism;
a color of the new organism;
a growth rate of the new organism;
a metabolic characteristic of the new organism;
an analyte to be produced by the new organism;
a volume of production of an analyte to be produced by the new organism;
a chemical concentration of an analyte to be produced by the new organism;
an isomer of the analyte to be produced by the new organism;
a resistance of the new organism to a disease;
a resistance of the new organism to attack by a pest;
a resistance of the new organism to use of a pesticide; and
a resistance of the new organism to use of a herbicide.

20. A computer-implemented method comprising:
receiving, at a processor, an indication of a sought-for trait of a new organism from an input device;
providing the sought-for trait to inputs of at least one neuromorphic device coupled to the processor, wherein:
the at least one neuromorphic device comprises multiple sets of hardware components;
each set of hardware components is configured to store at least one trained parameter of multiple trained parameters of trained neuromorphic configuration data to implement an artificial neuron of multiple artificial neurons of a neural network; and
the neural network is configured by at least a portion of the trained neuromorphic configuration data to derive and provide at outputs of the at least one neuromorphic device a proposed genome or a proposed epigenome of the new organism based on the sought-for trait provided to inputs;
retrieving, from the outputs of the at least one neuromorphic device, the proposed genome or the proposed epigenome of the new organism derived by the neural network;
transmitting the proposed genome or the proposed epigenome derived by the neural network to a printing device to enable generation of genetic or epigenetic material of the new organism;
generating a new organism entry in a usage data set, wherein:
the usage data set comprises multiple organism entries; and
each organism entry comprises trait data indicative of at least one trait of a corresponding organism, and biological data indicative of a genome or an epigenome of the corresponding organism;
following generation and cultivation of the new organism, operating a trait detection device to detect an observed trait of the new organism or of a derivative of the new organism;
storing an indication of the observed trait as the trait data within the new organism within the new organism entry; and
using at least the new entry to further train the neural network.

21. The computer-implemented method of claim 20, further comprising training the neural network with at least the portion of the usage data set, wherein the training comprises, for each organism entry of the usage data set, performing operations comprising:
providing the trait data to the inputs of the at least one neuromorphic device; and
providing the biological data to the outputs of the at least one neuromorphic device.

22. The computer-implemented method of claim 20, wherein:
each organism entry of the usage data set further comprises cultivation data indicative of a cultivation environment condition of the corresponding organism;
the neural network is further configured by at least the portion of the trained neuromorphic configuration data to derive and provide at the outputs of the at least one neuromorphic device a proposed cultivation environment condition based on the sought-for trait provided to the inputs of the at least one neuromorphic device; and
the method further comprises:
operating a cultivation environment system to cultivate the new organism in accordance with the proposed cultivation environment condition, and to monitor a cultivation environment condition of the new organism that is observed during cultivation of the new organism;
following cultivation of the organism, comparing the observed cultivation environment condition to the proposed cultivation environment condition; and
in response to a divergence between the observed cultivation environment condition and the proposed cultivation environment condition that exceeds a predetermined threshold, storing an indication of the observed cultivation environment condition as the cultivation data in the new organism entry to enable further training of the neural network with the new organism entry.

23. The computer-implemented method of claim 22, further comprising, in response to the divergence between the observed cultivation environment condition and the proposed cultivation environment condition that does not exceed the predetermined threshold, storing an indication of the proposed cultivation environment condition as the cultivation data in the new organism entry to enable further training of the neural network with the new organism entry.

24. The computer-implemented method of claim 20, further comprising:
following generation and cultivation of the new organism, operating a genome/epigenome detection device to identify a genome or epigenome that the new organism is observed to have;
comparing the observed genome to the proposed genome, or the observed epigenome to the proposed epigenome; and
in response to a divergence between the observed genome and the proposed genome, or between the observed epigenome and the proposed epigenome, that exceeds a predetermined threshold, storing an indication of the observed genome or epigenome as the biological data in the new organism entry to enable further training of the neural network with the new organism entry.

25. The computer-implemented method of claim 24, further comprising, in response to the divergence between the observed genome and the proposed genome, or between the observed epigenome and the proposed epigenome, that does not exceed the predetermined threshold, storing an indication of the proposed genome or epigenome as the biological data in the new organism entry to enable further training of the neural network with the new organism entry.

26. The computer-implemented method of claim 20, further comprising:
performing, by the processor, a regression analysis with the sought-for trait and the usage data to determine a probability of success in generating the new organism to have the sought-for trait;
outputting an indication of the probability on a display coupled to the processor, along with a request for confirmation to proceed with generating the new organism; and
delaying, by the processor, at least the transmission of the proposed genome or the proposed epigenome to the printing device until confirmation to proceed with generating the new organism is received from the input device.
